(19) United States
(12) Patent Application Publication
(10) Pub. No.: US 2026/0225686 A1
(43) Pub. Date: Aug. 6, 2026

(54) SYSTEM AND METHOD FOR ELECTRIC HUB MOTORS

(71) Applicant: ATMOSPHERIC MINING LLC, Vernon (CA)

(72) Inventors: Edgardo C. Dacanay, Jr., North Vancouver (CA); Tyler K. Anderson, Edmonton (CA); Travis L. McCracken, Vernon (CA)

(21) Appl. No.: 19/458,405

(22) Filed: Jan. 23, 2026

Related U.S. Application Data
(60) Provisional application No. 63/748,896, filed on Jan. 23, 2025.

(51) Int. Cl. B62M 6/65; B60L 7/12; B62M 6/80

(52) U.S. Cl. CPC B62M 6/65; B60L 7/12; B62M 6/80; B60L 2200/12; B60L 2220/16; B60L 2220/44

(57) ABSTRACT

Disclosed are embodiments of a hub motor adaptable for integration into mobility systems. The hub motor includes a synchronous permanent magnet brushless direct current (BLDC) outrunner mechanism configurable in at least one of a 6-, 9-, or 12-phase configuration and a stator having integrated commutation and regeneration circuitry. Additionally, the hub motor includes a hub-shell reaction flange to transmit combined inputs of motor-assist to a hub shell body.

### CROSS-REFERENCE TO RELATED APPLICATIONS

The present application claims priority to U.S. Provisional Patent Application No. 67/748,896, filed Jan. 23, 2025, which is incorporated herein by reference in its entirety for all purposes.

### TECHNICAL FIELD

The disclosure relates generally to the field of electric hub motors, and specifically and not by way of limitation, some embodiments are related to electric hub motor designs and configurations that may be adaptable for a variety of vehicular and mechanical applications.

### BACKGROUND

In the rapidly evolving landscape of the cycling industry, hub motors have emerged as pivotal components, particularly in the realm of electric vehicles, with e-bikes being a prime example. These hub motors play a central role in propelling electric bicycles, significantly influencing their efficiency, safety, and versatility.

Recent years have witnessed transformative trends, driven both by consumer preferences and technological advancements. Notably, there's been a surge in demand for motor-assisted cycles, encompassing various categories such as E-bikes, pedelecs (pedal electric cycles), and electric bicycles. These vehicles have redefined urban mobility, offering riders an environmentally friendly and efficient means of transportation.

Simultaneously, a groundbreaking shift has occurred with the introduction of the thru-axle wheel hub standard, encompassing both Boost and non-Boost variants. This standardization represents a significant leap forward, enhancing structural integrity and significantly improving wheel retention mechanisms. Thru-axle hubs are engineered to accommodate a wider range of gear cassettes, typically in the 10-12 speed range, making them a fundamental component of modern cycling technology.

However, the integration of these advancements poses unique challenges for hub motors, especially those designed for original equipment manufacturing. Many of these motors employ traditional open-dropout compatible threaded rod axles, a design choice that stands in stark contrast to the more robust and safety-conscious thru-axle mounting system.

Another concern revolves around the hub flange spoke count. Many hub motors adhere to a conventional 36-hole design, which, regrettably, misaligns with the 28/32-hole specifications commonly found in modern high-end cycling wheel rims. This incongruity not only affects compatibility but also raises questions about the motor's adaptability to contemporary cycling technology.

Moreover, when it comes to performance standards, there exists a significant gap, particularly in terms of ASTM-F2043-13 terrain category ratings. Many hub motors either lack verification under this standard or are rated at ASTM-F2043-13 CAT 1 or 2. These ratings imply a limited scope of usage, especially in challenging terrains and trail riding scenarios.

Additionally, there's the issue of compatibility with wide range freehub cassette gears. A substantial number of hub drive motors opt for the freewheel cassette system, limiting both the cyclist's climbing capabilities and their ability to choose from a wide range of freehub cassette brands and configurations. This also hampers adjustments to the chain-line, particularly in single speed configurations.

Given this backdrop, there is a need for the evolution of hub motors. These motors may be tailored to meet the contemporary demands of the e-bike industry while effectively addressing the identified challenges. They may seamlessly integrate with the latest technical standards, ensuring not only compatibility but also optimal performance.

In response to these evolving dynamics, the article described in this disclosure seeks to resolve the technical and market shortcomings of hub drive systems. It endeavors to provide an innovative and future-proofed wheel mounting system, boasting an ASTM-F2043-13 CAT3/4 terrain rating. Additionally, it emphasizes compatibility with brand-name aftermarket components, ensuring that hub motors remain at the forefront of electric bicycle technology. This comprehensive solution caters not only to original equipment manufacturers but also to the broader spectrum of e-bike enthusiasts and riders, reinforcing the pivotal role of hub motors in the electrified future of cycling.

To meet the evolving demands of the various industries using motors, such as the e-bike or e-cycling industry and to address the challenges posed by changing wheel mounting standards, there is a pressing need for an advanced hub drive motor system. Such a motor system should provide a technologically superior and versatile solution for both manufacturers and cyclists, ensuring optimal performance while adapting to the changing landscape of the industry.

In view of these industry conditions, the present disclosure provides a structurally integrated electric hub motor system that is compatible with modern thru-axle standards, supports high-strength wheel assemblies, and enables improved torque density, efficiency, and durability through advanced magnetic, mechanical, and electrical architectures.

### SUMMARY

In one example implementation, an embodiment includes a hub motor featuring a stator of laminated silicon steel to reduce eddy current losses and a rotor with an outrunner design and Halbach array, complemented by real-time thermal sensors and a user interface for variable pedal assistance levels.

Disclosed are example embodiments of a hub motor adaptable for integration into mobility systems. The hub motor includes a synchronous permanent magnet brushless direct current (BLDC) outrunner mechanism configurable in at least one of a 6-, 9-, or 12-phase configuration and a stator having integrated commutation and regeneration circuitry. Additionally, the hub motor includes a hub-shell reaction flange to transmit combined inputs of motor-assist to a hub shell body.

Disclosed are example embodiments of an e-bike system. The e-bike includes a hub motor including a synchronous permanent magnet brushless direct current (BLDC) outrunner mechanism configurable in at least one of a 6-, 9-, or 12-phase configuration, a stator having integrated commutation and regeneration circuitry, and a hub-shell reaction flange to transmit combined inputs of motor-assist to a hub shell body. The e-bike includes a bike frame designed around said hub motor, a thru axle securing the hub motor within the drive wheel of the bike, and a crank-mounted cadence counter configured to gauge pedal speed and activate the hub motor's power assist accordingly. The e-bike also includes a human-machine interface allowing users to interact with the e-bike system, modify settings, view battery status, and perform diagnostic tests, and a wireless communication system between the hub motor and a crank-mounted strain gauge to measure force applied to the pedals and modulate the motor's torque in response. Additionally, the e-bike includes a regenerative braking system where the hub motor acts as a generator during coasting or descending to convert kinetic energy back into stored electrical energy.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a diagram illustrating an example of a cutaway view of an electric hub motor in accordance with the systems and methods described herein.

FIG. 2 is a diagram illustrating an exploded view of the mechanical components of the electric hub drive motor-generator, illustrating variations in the type of rotor carrier spoke flange used in the assembly.

FIG. 3 is a diagram illustrating a ¾ enclosed view of the motor-generator assembly, highlighting the use of a freehub driver unit and a shrouded power cable non-drive side end cap.

FIG. 4 is a diagram illustrating a side view of the motor-generator assembly, showing the Over Lug Dimension, Drive-side flange-to-disc brake flange distance, and Flange-to-flange width.

FIG. 5 is a diagram illustrating a ¾ enclosed view of the motor-generator assembly with a different hub spoke flange style, demonstrating the assembly's versatility.

FIG. 6 is a diagram illustrating a side view of the motor-generator assembly with an alternative hub spoke flange style, indicating measurements for different thru-axle spacings.

FIG. 7 is a diagram illustrating an individual machined part drawing of the rotor carrier body, emphasizing the 6-bolt disc brake rotor mount interface and the splined interface for the rotor carrier reaction flange.

FIG. 8 is a diagram illustrating a detailed view of the Freehub Engagement Reaction Flange, showcasing its multiple functions, including the ratcheting mechanism and environmental sealing.

FIG. 9 is a diagram illustrating the Non-Drive Side End Cap, detailing its features such as the power and sensor cable pass-through, support for the motor-stator support shaft, and protection against dirt and grime.

FIG. 10 is a diagram illustrating the motor rotor frame, highlighting its construction using a fused filament deposition (FDM) printing media and its optimized filament deposition pattern.

FIG. 11 is a diagram illustrating the motor rotor assembly, showcasing the reluctance optimized Halbach array and the indexing notches for assembly alignment.

FIG. 12 is a diagram illustrating the motor stator frame, featuring 24 T beam sections joined by an internally 6-splined disc and constructed using FDM printing.

FIG. 13 is a diagram illustrating the completed motor stator assembly, with a 12-pole stator on a 24 T-beam frame and the coil out wire interconnects creating distinct magnetic engagement areas.

FIG. 14 is a diagram illustrating a detailed view of the Motor Stator Support Shaft, showing its complex machined features, such as the splines to prevent rotation of the stator assembly and the port holes for wire pass-through.

FIG. 15 is a diagram illustrating the freehub driver body, highlighting its design to interface with various types of ratcheting mechanisms.

FIG. 16 is a diagram illustrating the drive side endcap, illustrating its role in supporting the freehub driver body and providing environmental sealing.

FIG. 17 is a diagram illustrating an individual machined part drawing of an alternative rotor carrier body, demonstrating the use of a different type of rotor carrier spoke flange.

FIG. 18 is a diagram illustrating an individual machined part drawing of the rotor carrier body, showing the 83 mm bolt-circle-diameter for the disc brake rotor mount interface and the splined interface for the rotor carrier reaction flange.

FIG. 19 is a diagram illustrating a bicycle including an integrated hub motor as previously described in FIG. 1.

FIG. 20 is a diagram illustrating another example embodiment of a hub motor in accordance with the systems and methods described herein.

FIG. 21 is a diagram illustrating an example stator core pattern in accordance with the systems and methods described herein.

FIGS. 22-23 are diagrams illustrating examples of strong and weak magnetic fields with a north pole and a south pole, using a standard magnet layout, in accordance with the systems and methods described herein.

FIGS. 24-25 are diagrams illustrating strong and weak magnetic fields with a north pole and a south pole, but employing an alternative magnet layout, in accordance with the systems and methods described herein.

FIGS. 26-27 are diagrams illustrating examples of strong and weak magnetic fields along a rotor, in accordance with the systems and methods described herein.

FIGS. 28-30 are diagrams illustrating examples of rotors, in accordance with the systems and methods described herein.

FIGS. 31-32 are diagrams illustrating examples of rotors, in accordance with the systems and methods described herein.

FIGS. 33-34 are diagrams illustrating examples of a stator core having a series of coils, in accordance with the systems and methods described herein.

FIG. 35 is a diagram illustrating an example of a stator core having a series of coils situated within a rotor, showcasing their relative positions and alignments, in accordance with the systems and methods described herein.

FIG. 36 is a diagram illustrating a more detailed view of the stator core having a series of coils within a rotor, emphasizing the intricacies of their physical connections and interactions, in accordance with the systems and methods described herein.

FIG. 37 is a diagram illustrating the electromagnetic aspects, displaying an example of a stator core with coils inside a rotor, and particularly highlighting the generated magnetic field lines and their influence on the rotor's motion, in accordance with the systems and methods described herein.

FIG. 38 is a diagram illustrating the electromagnetic interactions, featuring a stator core with coils inside a rotor, while distinctly focusing on the magnetic field lines and their variations during different operational phases, in accordance with the systems and methods described herein.

FIG. 39 is a diagram illustrating the operational aspect, portraying an example of a stator core with coils within a rotor and placing a significant emphasis on the coil firing patterns, shedding light on the sequence and timing of electrical activations, in accordance with the systems and methods described herein.

FIG. 40 is a diagram illustrating an example motor coil driver leg, detailing the components and connections may be for driving motor coils, in accordance with the systems and methods described herein.

FIG. 41 is a diagram illustrating an example motor coil driver circuit having three motor coil driver legs of FIG. 40, in accordance with the systems and methods described herein.

FIG. 42 is a diagram illustrating an example of motor coil driver circuit firing order, in accordance with the systems and methods described herein.

FIG. 43 is a diagram illustrating a single rectifier leg, illustrating its individual components and their functions in the process of electrical rectification, in accordance with the systems and methods described herein.

FIG. 44 is a diagram illustrating a comprehensive diagram of three interconnected rectifier legs, forming a complete motor rectifier circuit and emphasizing their combined roles in converting alternating current (AC) to direct current (DC), in accordance with the systems and methods described herein.

FIG. 45 is a diagram illustrating three rectifier legs in a motor rectifier circuit, in accordance with the systems and methods described herein.

FIG. 46 is a block diagram illustrating an example motor system, in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The following detailed description describes example embodiments of electric hub motor systems, assemblies, and related methods. These embodiments are provided to enable persons skilled in the art to make and use the disclosed subject matter, and to illustrate representative structural, electrical, and functional configurations of the disclosed hub motor architectures. The disclosed embodiments are not intended to limit the scope of the claims. Rather, variations, substitutions, and modifications may be made without departing from the principles and advantages described herein. Unless otherwise stated, relative terms such as “inner,” “outer,” “axial,” “radial,” “drive side,” and “non-drive side” are used solely for convenience of description with reference to the orientations shown in the drawings. In particular, some example embodiments address structural compatibility with modern thru-axle bicycle standards, enhanced torque density through multi-phase emulation and reluctance tuning, and integrated mechanical reaction management between a motor rotor and a freehub cassette driver.

As used herein, the term “hub motor” refers to an electric motor assembly integrated within a wheel hub structure and configured to transmit torque directly to a wheel rim through a hub shell, without an intermediate chain, belt, or shaft drive mechanism.

The term “outrunner motor” refers to a motor configuration in which a rotor circumscribes a stator and rotates about an external diameter of the stator.

The term “phase emulation” refers to a motor control technique in which a stator having a fixed number of electrical output conductors is selectively energized in different firing sequences to electrically emulate a greater number of motor phases than the number of physical conductors.

The term “inverse common polarity principle” refers to a control method in which paired stator windings are driven with alternating polarity relationships such that multiple apparent phase groups are produced from a reduced number of electrical conductors.

The term “reluctance tuning” refers to the deliberate geometric and angular positioning of magnetic elements relative to a stator such that magnetic flux paths are preferentially shaped to increase torque density, reduce flux leakage, and reduce magnetic hysteresis losses.

The term “Halbach array” refers to an arrangement of permanent magnets in which the magnetization directions are sequentially rotated so as to reinforce the magnetic field on one side of the array while substantially canceling the field on the opposite side.

The term “off-radial-tangent magnet positioning” refers to permanent magnets oriented at an angular offset relative to a radial tangent of a rotor circumference to improve magnetic field focusing toward a stator.

The term “microlamination” refers to a layered magnetic structure formed by successive deposition of ferromagnetic composite material in thicknesses less than approximately 0.5 millimeters, thereby reducing eddy current losses.

The term “ferromagnetic composite thermoplastic” refers to a polymer matrix material containing magnetically permeable particulate fillers that together exhibit directional magnetic conductivity.

The term “flux gate pattern” refers to a directional filament deposition arrangement within a composite magnetic structure that guides magnetic flux along predefined paths.

The term “reaction flange” refers to a structural interface component configured to receive combined torque from both a motor rotor and a freehub cassette driver and transfer said torque to a hub shell body.

The term “hub-shell reaction flange” refers to a reaction flange positioned between a motor rotor and a freehub cassette driver.

The term “thru-axle” refers to a removable axle extending fully through a hub assembly and engaging threaded dropouts or axle retainers on opposing sides of a frame.

The term “ASTM F2043-13 terrain category rating” refers to standardized bicycle frame and component strength classifications published by ASTM International.

The term “freehub cassette driver” refers to a ratcheting mechanism configured to transmit rotational force from a cassette sprocket assembly to a hub body.

The term “emulated multi-phase motor” refers to a motor in which electrical firing sequences produce an apparent phase count greater than the number of physical stator windings.

The term “regenerative braking” refers to an operating mode in which a motor converts mechanical rotational energy into electrical energy during deceleration.

The term “human-machine interface” refers to a user-accessible electronic interface providing operational control and system feedback.

The term “commutation circuitry” refers to electronic circuitry configured to control timing and polarity of stator coil energization.

The term “integrated commutation circuitry” refers to commutation circuitry located within the hub motor assembly.

The term “sector angle” refers to the angular spacing between successive magnetic engagement regions of a stator or rotor.

The term “flux interruption” refers to magnetic field variation occurring during sector-to-sector transition.

The term “environmental sealing” refers to structural features configured to inhibit ingress of moisture, dust, or debris.

The term “press-fit interference” refers to a mechanical joining technique in which mating components are joined by elastic deformation.

The term “thermal press-fit” refers to press-fit assembly achieved through differential thermal expansion.

The term “hub shell body” refers to the outer structural shell to which wheel spokes are mounted.

The term “hub motor assembly” refers collectively to a stator, rotor, support shaft, reaction flange, hub shell body, and associated bearings and seals.

Unless otherwise indicated, the following terms are defined for purposes of clarity in this specification and are not intended to limit the scope of the claims.

As used herein, the terms “hub motor,” “hub drive motor,” and “motor-generator” may be used interchangeably unless the context indicates otherwise.

In recent years, the cycling industry has witnessed significant trends driven by both consumer demand and technological advancements. One such trend is the increased popularity and availability of motor-assisted cycles, commonly known as e-bikes or electric bicycles. Alongside this, a new standard for wheel axle mounting, known as the thru-axle wheel hub (including Boost and non-Boost variants), has been gradually adopted across the industry. This standard offers improved structural strength and stiffness at the wheel dropouts, enhances wheel retention, and is compatible with a wide range of 10-12 speed gear cassettes.

Despite these advancements, the consumer market has seen a rise in budget-friendly, white-label mass-market electric bicycles. These products have often displaced many brand-name manufacturers, whose dealer networks primarily consist of independent local bicycle stores. These brand-name manufacturers have struggled to compete on price with white-label bicycles, especially in the high-end electric bicycle categories, leading to limited success in offering price-competitive options.

One of the measures some brand-name manufacturers have taken to compete on price is to use the same hub motor technology as white-label manufacturers. However, this approach has resulted in technical compromises, particularly in wheel retention safety, terrain category ratings (ASTM F2043-13), and overall weight. Existing hub drive motors typically use open-dropout compatible threaded rod axles, which are incompatible with the newer, safer, and stronger thru-axle wheel mounting system. Additionally, these motors often feature 36-hole hub flanges, which are incompatible with high-end aftermarket cycling wheel rims that are typically 28/32 hole drilled. Furthermore, most hub drive motors are not rated for aggressive trail riding (ASTM-F2043-13 CAT 1 or 2), and they are often incompatible with wide-range freehub cassette gears, limiting the climbing ability of cyclists and their ability to choose desired components.

To address these challenges and provide a technically superior hub drive system for manufacturers, cyclists, and conversion applications, the present disclosure introduces an innovative hub drive system. This system resolves the technical and market shortcomings of current hub drive systems by offering a future-proofed wheel mounting system, ASTM-F2043-13 CAT4/5 terrain rating, and compatibility with brand-name aftermarket components. By focusing on these key features, the disclosed hub drive system aims to meet the evolving needs of the cycling industry and provide a competitive advantage to brand-name manufacturers and independent local bicycle stores.

Some embodiments may include a 6-, 9-, or 12-phase outrunner-type direct-drive permanent magnet synchronous reluctance brushless direct current electric hub motor generator (XPMSynRMG). The motor generator may be enclosed within a hub shell with 28-hole/32-hole straight-pull or J-bend flanges and includes a Booster and a non-Boost spacing ISO-6 bolt disc brake mounting flange. The hub shell may also incorporate a hub shell reaction flange positioned between the motor rotor and the freehub cassette driver. Supporting this assembly may be a hollow motor-stator support shaft containing machined conduits for 6 direct current power wires and 4-pin communication bus wires, bundled in a connector on the non-drive side of the hub motor. This shaft may also accommodate a 12 mm thru axle to support the hub motor on the rear dropouts of the cycle. Some embodiments may be controlled and regulated by various methods, including a crank-mounted cadence counter for power assist activation, a wirelessly communicating crank-mounted strain gauge for motor torque modulation, a stator coil cycle frequency counter for speed control and measurement, a human-machine interface for system control and configuration, and/or a power supply such as a battery.

Some embodiments may be designed for light mobility appliances, focusing on technical specifications suitable for cycles and scooters utilizing a 12 mm thru axle as a drive wheel securing system. Some aspects may provide entry-level electric pedal-assisted bicycles and scooters, with a particular emphasis on applications where drive wheel retention safety is critical, such as off-road use. Additionally, some embodiments may be well-suited for aftermarket motor-assisted cycle conversion kits designed for 12 mm thru axle compatible cycles, providing a versatile and adaptable solution for enhancing the performance and functionality of existing cycle models.

Some embodiments pertain to an electric hub drive motor designed to be compatible with the 12 mm thru axle mounting system, 28/32 hole drilled aftermarket rims, and freehub cassettes, suitable for use in advanced technical terrain features.

The human-machine interface of the electric bicycle powertrain system may include functions for on/off control via a button, optionally secured additionally by a mechanical switch key or radio frequency identification device for vehicle immobilization. It may also provide battery charge status, built-in diagnostic test status, and speed and power assist modes.

The human-machine interface communicates with the motor master controller via a 4/5-wire CAN-bus network connection. The motor master controller, located near a battery holster, receives power from a 36V-48V battery pack and provides power outputs to the human-machine interface, the hub drive motor, and optionally an accessory circuit for rider devices such as USB power connection.

The motor master controller receives signal inputs from the human-machine interface via 5-wire CAN-bus connection, the hub drive motor 4 wire CAN-bus connection, an analog hall-effect sensor pulse signal from the crank mounted cadence counter, and an optional wireless protocol receiver communicating with the human-machine interface, providing crank torque and speed information via a spindle or chainring mounted power meter. The optional power meter supplies the motor controller information to allow for more precise power modulation of the motor assist system based on torque applied to the cranks as opposed to just a motion-sensitive cadence counter.

The hub drive motor is constructed around the motor-stator support shaft, machined from strain-hardened 7000-series aluminum alloy, due to its non-magnetic properties, resistance to corrosion, and surface hardness when heat treated and anodized. The motor-stator support shaft contains Schnorr-type axial serrations at both ends of the hub shaft lugs and a directional anti-rotation key at the non-drive side of the hub motor. This key also functions as a slot and mounting plate for the motor power and communication bus connector. The motor-stator support shaft has a 12 mm drilled shaft hole for the 12 mm thru axle and will vary in length depending on the end-application hub axle width of the particular bicycle, covering rear thru axle standards such as 142×12 mm, 148×12 mm Boost, 157×12 mm SuperBoost, 177×12 mm Fat, and 197×12 mm Fat.

The electronic coil driver commutation controller contains a 12 pole, 6 wire stator, 18 pole, 6 wire stator, and a 24 pole, 6 wire stator, enabling the motor to be controlled in 3-, 6-, 9-, or 12-phase coil firing modes respectively. The electronic motor coil driver arrangement is a six out wire, three leg H-bridge firing circuit, inherent with the emulated 6, 9, and 12 phase motor designs in their simplest possible configuration due to the inverse common polarity principle. In some situations due to application speed restrictions, a pedal electric assist bicycle may only need an emulated 6-, 9- or 12-phase direct drive motor due to maximum speed restrictions permitted by regulations.

The hub motor's power electronics consist of a motor master controller, a six-out wire, three-channel motor coil driver, a motor regeneration rectifier circuit, and a bi-directional voltage regulator to govern propulsive power, regeneration strength, and current. The motor master controller applies and receives signal inputs from the bidirectional voltage regulator, motor coil driver circuit as well as the battery. The motor rectifier circuit converts inductive feedback into a recharging current with MOSFET governed voltage and current modulation and consists of 3 parallel capacitor filtered rectifier legs connected to the six out wires of the motor stator. The motor coil driver circuit features three coil H-bridge legs which dictate the current flow direction in each coil firing group for a given motor rotor sector angle.

The motor operation in emulated 6-, 9- or 12-phase configuration, dictated by the stator pole and winding arrangement, provides high motor torque at low wheel speeds and high crank loads such as a steep technical climb, especially in the case of a single-speed gear configuration, but the maximum commutation frequency under load of the motor does not exceed the expected rotational speeds of the bike wheel when ridden. The motor assist cutoff is governed by the outputs of a hall-effect sensor mounted near the outer edge of the motor speed in line with the rotor permanent magnets which is also used to control the motor stator firing sequence. The hall effect sensor outputs also provide bicycle speed data to the human-machine interface.

Conversely, when the hub drive motor is subject to coasting, the motor acts as a regenerative brake to both recharge the battery and provide rear bias speed and stability control in downhill riding situations. This reduces rear disc brake pad and rotor wear but also allows for a smaller form factor, lightweight traction battery to be used, reducing bicycle weight, hardware costs and charging time. The shallow sector angles of the motor stator design and the 6-, 9- or 12-phase provide proportional flux interruption akin to a gear reduction system spinning a typical 3-phase motor system at double or triple the speed, therefore a planetary gear reduction system is eliminated in this hub motor design.

The hub motor's outrunner rotor features a fused filament deposition model (FDM) printed rotor frame with permanent magnet segments arranged under a Halbach array and positioned off-radial-tangent within the rotor frame for optimized magnetic field flux alignment, referred to as reluctance tuning. The combination of a Halbach array in the permanent magnets and off-radial-tangent positioning in the outrunner rotor ensures a concentrated magnetic field with minimal field flux interference and reduced magnetic hysteresis losses.

This combination of a strong, shock load-resistant electric motor contributes to the hub drive motor's ability to withstand high impact riding conditions as stipulated under ASTM-F2043-13 CAT 4/5. The hub drive motor freehub engagement reaction flange made from 7075-T6 aluminum alloy is designed to absorb the combined output of the electric motor assist provided via the motor rotor and the engagement of the freehub cassette driver and transfer it to the rotation of the hub shell body. The hub shell reaction flange absorbs riding impact forces experienced by the hub shell body and transfers it to the drive side of the motor-stator support shaft.

The freehub engagement reaction flange also contains the appropriate interface system for engagement with the freehub cassette driver. The freehub cassette driver is inserted in-line with the motor-stator-support shaft, engaged to the hub shell reaction flange and secured to the support shaft by press fit insertion and a sealing end cap. The freehub cassette driver can be interchanged to suit different freehub mounting standards such as HyperGlide/PowerGlide®, Microspline®, XDR®, and the accompanying geared cassettes with varying numbers of speeds, gear ranges, and product tiers. The rotor carrier body features the main enclosure for the motor internals—the 28/32 hole straight pull spoke flanges to mount both the spokes and wheel rim as well as an 83 mm BCD 6-bolt disc brake rotor mounting interface. The 83 mm BCD six bolt disc brake interface reduces the magnitude of thermal-mechanical warp common with larger disc brake rotors using the ISO 6-Bolt and Shimano Centrelock mounting standards. Additionally, the 83 mm BCD standard is currently being used by Tektro and SRSuntour as a disc brake mounting interface for the SRSuntour motor due to the need for a stronger rear axle mounting system and spatial limitations of the ISO 6-bolt mounting system.

One embodiment may be an advanced electric hub drive motor tailored for cycles and scooters. In some embodiments, this motor may uniquely align with the 12 mm thru axle system and may be suitable for high-end bicycle rims having varied spoke configurations. Boasting compatibility with freehub cassettes, the hub motor may be designed to handle challenging terrains, as evidenced by its adherence to the ASTM-F2043-13 CAT3/4 standards. The motor's architecture may integrate a human-machine interface, which facilitates toggling power, monitoring diagnostics, and adjusting settings. This interface may communicate through a 5-wire CAN-bus network to a motor master controller, which derives power from a battery pack. The motor's design, inclusive of its ability to modulate power based on torque, enables it to deliver high torque even at low speeds. This motor integrates an innovative 6- or 9-phase stator mechanism that negates the need for external gear systems, making it efficient and compact. Furthermore, the hub motor may be a built-in coil driver system and integrated commutation hardware, mean fewer external connections are needed. Notably, this hub motor may also feature regenerative braking, converting coasting action into battery-charging energy, emphasizing efficiency and utility. However, the hub motor design may have certain brake compatibility limitations, including constraints on rotor size and specific mounting interfaces.

Some embodiments relates to a hub drive electric motor specifically designed for use in cycles and scooters. The motor may utilize, e.g., a 12 mm thru axle and may be engineered to withstand tough terrain conditions as per the ASTM-F2043-13 CAT4/5 standards, distinguishing it from other hub drive motors available in the market.

The electric motor system may be designed to automatically optimize its output performance for speed, torque, and efficiency by controlling the firing of individual stator coils. This optimization may be based on factors such as motor speed, load, power demand by user crank strain, and energy conservation, ensuring an efficient and responsive riding experience.

The hub shell body of the electric motor system may be compatible with high-end bicycle rims that have 28/32 spoke holes. It may also be designed to be strong enough to withstand terrain conditions as per the ASTM-F2043-13 CAT4/5, setting it apart from other available hub drive motors in the market.

The freehub engagement reaction flange transmits the combined inputs of the motor-assist through the motor rotor and the freehub cassette driver body to the hub shell body, ensuring smooth and efficient power transfer.

The motor may utilize an emulated 6-, 9-, or 12-phase wound motor stator and corresponding built-in solid-state motor commutation hardware. This design allows the elimination of a gear reduction system, as the motor's maximum theoretical speed is dictated by the limitations of field reversal frequency. However, a smaller sector angle in in the motor design may enable high peak torque density generally proportional to relative leverage, despite the motor's small form factor.

The motor stator assembly may contain motor speed and thermal sensors, as well as safety systems internal to the motor assembly, ensuring reliable and safe operation.

In an example, the hub drive motor assembly may include six motor power input wires and four sensor wires for thermal and speed/position sensing, providing comprehensive monitoring and control of the motor's performance.

The motor may be capable of delivering propulsive power for pedaling and regeneration power when coasting down hills. Propulsive and regeneration power can be adjusted via the human-machine interface, allowing for a customizable riding experience.

The motor rotor contains a permanent magnet configuration using a composite FDM ferromagnetic thermoplastic outrunner-type frame with reluctance aligned magnet segments individually assembled in a Halbach array. This innovative design contributes to the motor's efficiency and performance.

### Hub Motor

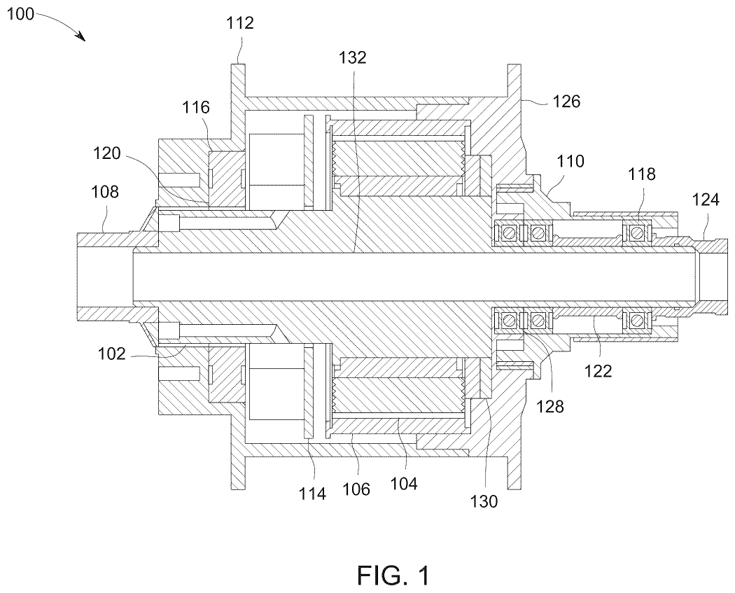

FIG. 1 illustrates an example of a cutaway view of an electric hub motor 100. In the illustrated embodiment of the electric hub motor 100, is the stator shaft 102, with a stator 104. Circumscribing the stator 104 is the rotor 106.

FIG. 1 also illustrates a non-drive side end cap 108 at an end of the electric hub motor 100 covering a shaft 132 generally running along a center axis of the electric hub motor. A bearing 116 (e.g., 16007 bearing in the illustrated example) may support one end of the stator shaft 102 and, in conjunction with the bearing 118 (e.g., 6902 bearing), may allow for rotation of the stator shaft 102. More specifically, bearing 116 may support stator shaft 102 and the bearing 118 may support the shaft 132, which may protrude from the stator shaft 102, e.g., opposite the side with the non-drive side end cap.

Within the designed structure of the hub motor, a particular component, the bearing insert 120, may have a role in ensuring optimal performance. This insert may specifically be tailored to operate with the bearing 116. The bearing insert 120 design and function may, in some embodiments, be engineered to offer a fit for the bearing 116, acting to contour to its form. This fitting may not just be about physical accommodation; it may serve a larger purpose. By providing such a fit, the bearing insert may be instrumental in ensuring the unhindered rotation of components, effectively minimizing any potential impediments. But the bearing insert 120 role may not stop there. Beyond facilitating rotation, the bearing insert might also act as a protective buffer. The bearing insert 120 may preemptively guard against direct contact between the bearing 116 and the stator shaft 102. Otherwise interactions could lead to undesirable wear and tear, potentially compromising the lifespan and efficiency of both components. Hence, the bearing insert 120 may not just be a passive component; the bearing insert 120 might be proactive, ensuring longevity and seamless operation within the hub motor assembly.

The bearing 118 (e.g., 6902 bearing) may be one of a series of bearings, two of which may be under a freehub driver 110. The freehub driver 110 (or freehub) may be a component on a bicycle rear hub that allows the rear wheel to turn without the pedals moving when the cyclist is not pedaling. The freehub driver 110 may contain a mechanism (usually a set of pawls and ratchets) that engages when the pedals are turned forward, driving the wheel, but disengages when the wheel is turning faster than the pedals, allowing it to “freewheel.” This feature may be beneficial when coasting or descending hills. Spacer 122 may be placed between the bearing 118 and the bearings near the freehub driver.

Within the structural assembly, the hub motor 100 may be within the confines of the non-drive hub body 112. This particular non-drive hub body 112 may be designed to interlock with the non-drive side end cap 108, thus ensuring that the hub motor 100 may be securely positioned at one distinct terminal end of the assembly. Serving as a counterbalance and situated diametrically opposite to the non-drive side end cap 108, at the other terminal end of shaft 132, is the intricately crafted vault hub drive cap 124. This setup provides a harmonious structural balance, ensuring optimal performance and durability. In the illustrated embodiment, a washer 128 may be located between two bearing at the freehub driver 110. A drive hub body 126 may couple to the non-drive hub body 112. The non-drive hub body 112 and the drive hub body 126 may form a cover that generally encloses e.g., the portion of the motor 100 including the stator shaft 102.

In the given illustrative embodiment, the particular placement and alignment of components can help ensure smooth functionality. The bearing 130, which could potentially be a 4060 thrust bearing or similar type, may indeed find its position nestled adjacent to the drive hub body 126. Furthermore, this bearing 130 may not just be a passive component; it may actively provide a bearing surface tailored for one extremity of the stator shaft 102, as depicted in the comprehensive diagrams. Zooming out to consider the overarching control mechanisms, there may be a dedicated PCB board 114. This board may serve as the central nervous system, ensuring that all components communicate and function as intended. Impressively, despite its significance in the operational hierarchy, the PCB board 114 may be discreetly mounted, almost hidden, within the confines of the non-drive hub body 112, maintaining a balance between aesthetics and function. This intricate arrangement may underscore the thoughtful engineering that went into designing a robust and efficient hub motor system. An example embodiment highlights the hub motor 100, which may be thoughtfully designed to integrate into a variety of mobility systems. These systems may include, but are not limited to, bicycles, scooters, electric skateboards, or other personal transportation devices. The design considerations for hub motor 100 do not just stop at the hub motor's integration; the motor's construction might employ advanced materials or innovative engineering techniques that set it apart from conventional designs. Furthermore, its adaptability suggests that the hub motor 100 may potentially fit into multiple configurations or environments, accommodating a wide range of user needs and preferences. Additionally, the hub motor 100 may come with a suite of features that can enhance the hub motor 100 performance, durability, and user experience. Each of these attributes, from its construction to its features, underscores the potential versatility and applicability of the hub motor 100 across diverse mobility platforms.

At the heart of this hub motor is a synchronous permanent magnet brushless direct current (BLDC) outrunner type mechanism, which can be configured in multiple phases, namely 6-, 9-, or 12-phase. This provides flexibility in controlling the motor's torque and speed depending on the user's requirements and the terrain's demands.

As described, the motor's inner construction features a stator 104, which may come equipped with an integrated commutation and regeneration circuitry. This configuration may aid in smooth power delivery and provides an energy regeneration feature, allowing for efficient battery usage. The stator 104 may be structured around a hollow motor-stator support shaft (e.g., stator shaft 102). This shaft, often made of non-magnetic materials like strain-hardened 304-series stainless steel, may provide resistance against corrosion and ensures longevity.

In some embodiments, a distinguishing feature of this hub motor may be the direct compatibility with 12 mm thru-axles (or other size thru axels on, e.g., e-bicycles of different axel size standards), making the hub motor suitable for modern bicycle and scooter models. This motor can be housed within a 28-hole or 32-hole straight pull flanged hub-shell, which may also feature an ISO-6 bolt disc brake mounting flange. This configuration may aid in offering compatibility with contemporary braking systems.

Within the intricate design of the hub motor, the electrical and data communication needs are paramount. To address this, the hub motor may predominantly rely on two direct current power wires, meticulously designed to ensure optimal power flow and minimal resistance. In tandem with these, there may be a dedicated communication bus wire, potentially characterized as a 5-pin communication bus wire, which isn't just a mere physical conduit. Instead, it may bridge the motor with external controllers, sensors, and other devices. This combination might be strategically engineered to not only guarantee efficient power delivery but also facilitate real-time, seamless communication with the motor controller. Such an arrangement may underscore the importance of constant feedback loops in maintaining the hub motor's peak performance and responsiveness in diverse scenarios.

The hub-shell reaction flange may be one component in some example embodiments. This particular feature may have been integrated with meticulous precision, and it doesn't operate in isolation. It may be pivotal in channeling the combined forces and inputs generated by the motor-assist. Furthermore, these inputs, once processed by the hub motor, may be adeptly channeled through the motor rotor, acting as a mediator of sorts. In conjunction with this, the freehub cassette driver also plays its part, ensuring that all the generated momentum and torque are efficiently transferred to the hub shell body. The presence of the hub-shell reaction flange might be a testament to the thoughtful engineering that prioritizes both power transmission and the longevity of the hub motor, ensuring it remains resilient even under demanding conditions.

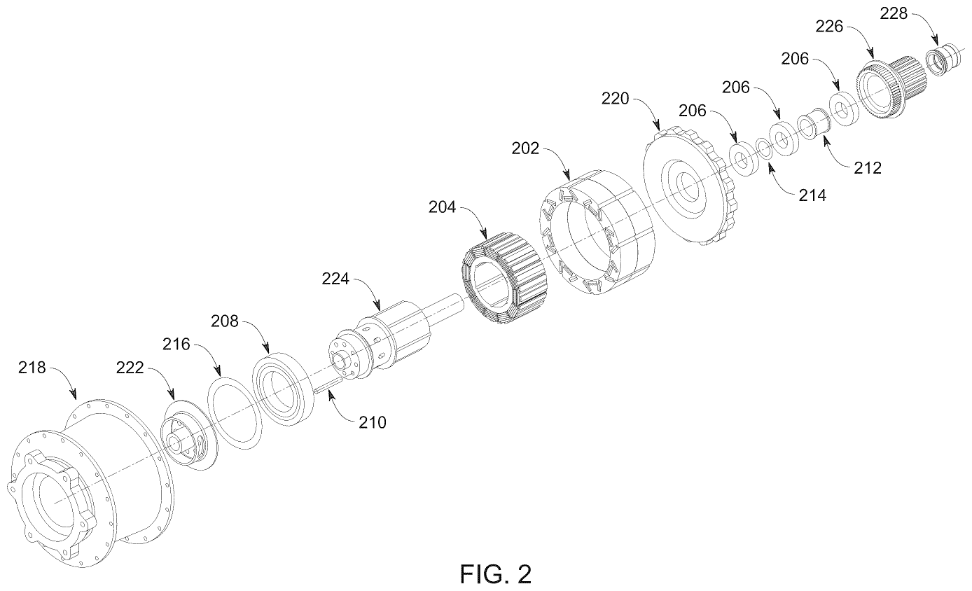

FIG. 2 is a diagram illustrating an exploded view of the mechanical components of the electric hub drive motor-generator, illustrating variations in the type of rotor carrier spoke flange. The assembly includes various components, with item 202 representing the type of rotor carrier (hub shell) spoke flange used in the assembly. Industry partner-defined components, which are not entirely dictated by the design of the Applicant (Indi Motor Corp), include items 202, 204, 214, 216, 218, 224, and 226. These components are subject to certain measurement and spatial constraints specified by the Applicant to ensure fitment. Items 206, 208, 210, 212, 220, 222, and 228 are manufactured and assembled by the Applicant and form the motor core. The motor-generator assembly may be held in place by thermal press fit, close tolerance hand fit, structural adhesive, and/or end-cap compression, depending on the specific component being joined, and may be designed to accommodate a 12 mm thru-axle.

FIG. 2 includes an MD-01955 MOTOR ROTOR ASY 202, MD-01957 STATOR ASY 204, three 6902 BEARINGS 28 mm OD×15 mm ID×7 mm TH 206, 16007 BEARING 62 mm OD×35 mm ID×9 mm TH 208, 1 PIN ⅛″ OD×1-⅛″ L 210, 1 SPACER 1 20.5 mm OD×15.5 mm ID×17.25 mm TH 212, SPACER 2 17.5 mm OD×15.5 mm ID×0.8 mm TH 214, TEFLON RING 62 mm OD×50 mm ID×1.6 mm TH 216, 9 1 MD-01950 ROTOR CARRIER (J-BEND) 218, 10 1 MD-01952 FREEHUB ENGAGEMENT REACTION FLANGE 220, MD-01953 NON DRIVE SIDE END CAP 222, MD-01958 MOTOR STATOR SUPPORT SHAFT 224, MD-01959 FREE HUB DRIVER BODY 226, and MD-01960 DRIVE SIDE CAP 228. It will be understood that these parts are just examples.

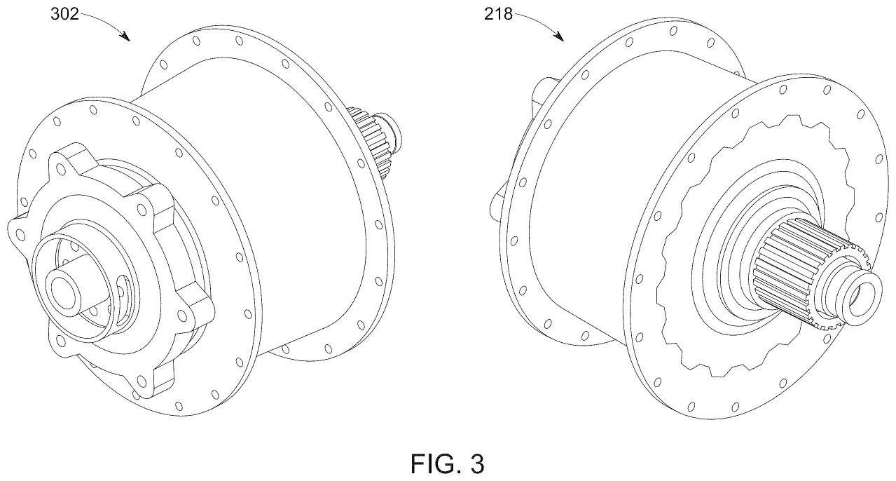

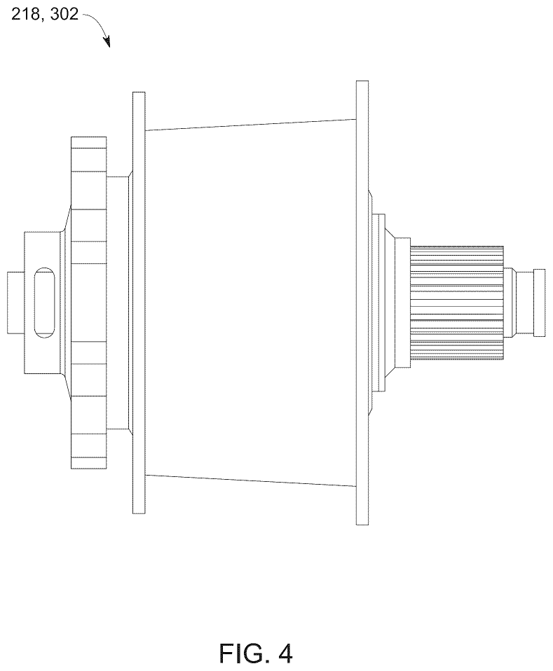

FIG. 3 is a diagram illustrating a ¾ enclosed view of the motor-generator assembly (Non-driver side 302, driver side 218), highlighting the use of a freehub driver unit and a shrouded power cable non-drive side end cap. FIG. 4 is a diagram illustrating a side view of the motor-generator assembly 218, 302, showing the Over Lug Dimension, Drive-side flange-to-disc brake flange distance, and Flange-to-flange width. The notable difference between the rotor carriers in these figures may the hub spoke flange styles, with FIG. 3 featuring a J-bend style and FIG. 4 displaying a straight-pull style. Common details in both figures include the use of a freehub driver unit and a shrouded power cable non-drive side end cap. The Over Lug Dimension, Drive-side flange-to-disc brake flange distance, and Flange-to-flange width are consistent in both figures, with measurements of 157.00 mm, 86.64 mm, and 68.96 mm, respectively. These dimensions correspond to the SuperBoost 12 mm thru-axle spacing, although the design accommodates different thru-axle spacings through adjustments in the motor stator support shaft length and flange-to-flange measurements.

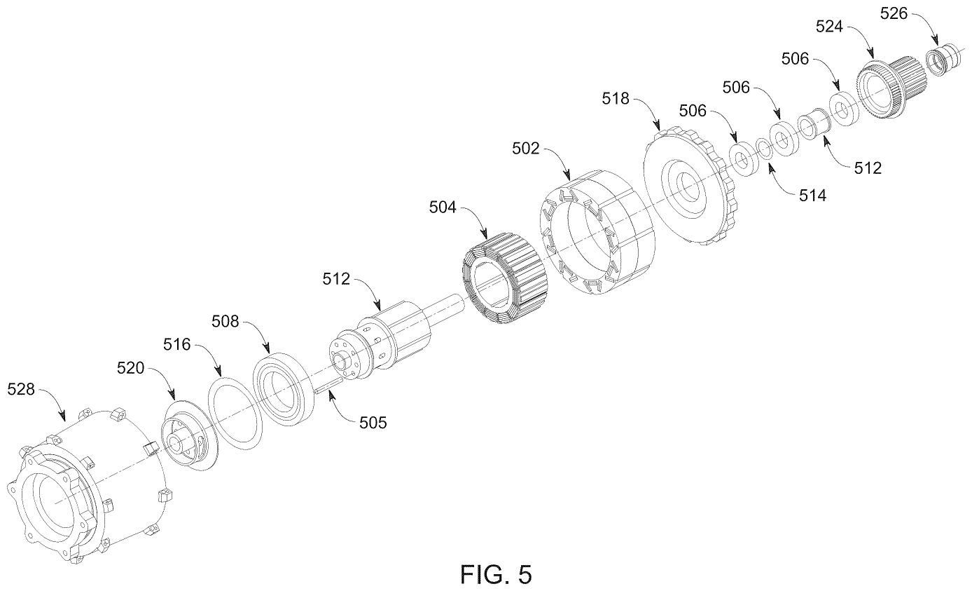

FIG. 5 is a diagram illustrating an exploded view of the mechanical components of the electric hub drive motor-generator, similar to FIG. 2, but with a different type of rotor carrier (hub shell) spoke flange, represented by item 500. The assembly includes industry partner-defined components such as items 500, 502, 512, 514, 516, 522, and 524, which are specified by the Applicant to ensure proper fitment with partner manufacturer-designed components. Items 504, 506, 508, 510, 518, 520, and 526 are manufactured and assembled by the Applicant and constitute the motor core. The assembly method for holding the motor-generator assembly in place may be consistent with that described for FIG. 2, accommodating a 12 mm thru-axle and utilizing thermal press fit, close tolerance hand fit, structural adhesive, and/or end-cap compression as needed.

FIG. 5 includes MD-01955 MOTOR ROTOR ASY 502, MD-01957 STATOR ASY 504, 6902 BEARING 28 mm OD×15 mm ID×7 mm TH 506, 16007 BEARING 62 mm OD×35 mm ID×9 mm TH 508, 5 1 PIN ⅛″ OD×1-⅛″ L 510, SPACER 1 20.5 mm OD×15.5 mm ID×17.25 mm TH 512, SPACER 2 17.5 mm OD×15.5 mm ID×0.8 mm TH 514, TEFLON RING 62 mm OD×50 mm ID×1.6 mm TH 516, MD-01952 FREEHUB ENGAGEMENT REACTION FLANGE 518, MD-01953 NON DRIVE SIDE END CAP 520, MD-01958 MOTOR STATOR SUPPORT SHAFT 522, MD-01959 FREE HUB DRIVER BODY 524, MD-01960 DRIVE SIDE CAP 526, and MD-01962 ROTOR CARRIER (STRAIGHT PULL) 528. It will be understood that these parts are just examples.

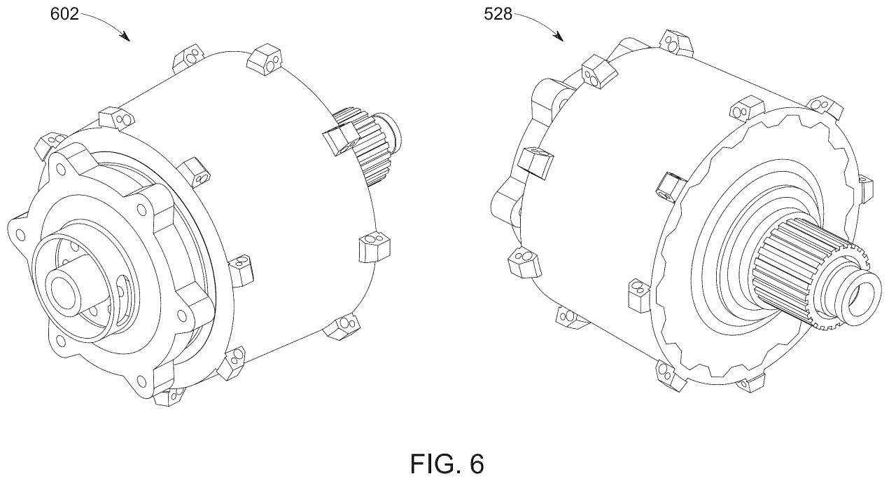

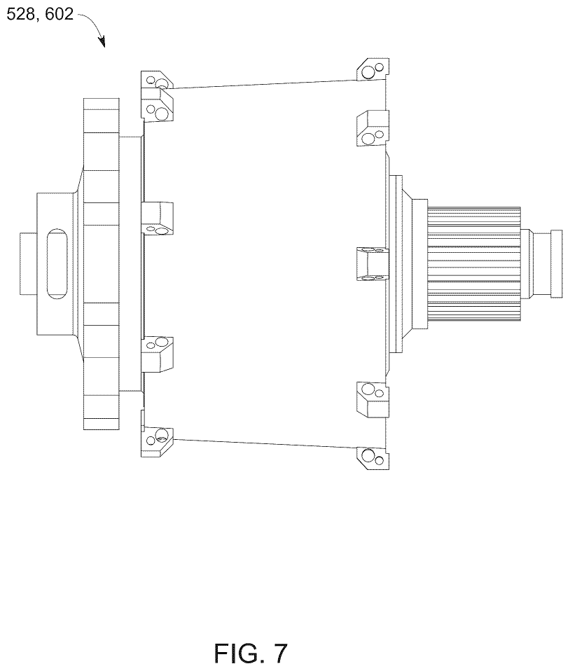

FIG. 6 is a diagram illustrating a side view of the motor-generator assembly with an alternative hub spoke flange style, indicating measurements for different thru-axle spacings (non-driver side 602, driver side 528). FIG. 7 is a diagram illustrating an individual machined part drawing of the rotor carrier body 528, 602, emphasizing the 6-bolt disc brake rotor mount interface and the splined interface for the rotor carrier reaction flange. FIGS. 6 and 7 are diagrams illustrating a side view and a ¾ enclosed view, respectively, of the motor-generator assembly, similar to FIGS. 3 and 4 but with variations in the hub spoke flange styles. FIG. 6 presents a side view with a straight-pull flange style, while FIG. 7 showcases a ¾ enclosed view with a J-bend flange style. Both figures highlight the use of a freehub driver unit and a shrouded power cable non-drive side end cap. The Over Lug Dimension of 157.00 mm may be consistent with the SuperBoost 12 mm thru-axle spacing, but the design also allows for the accommodation of different thru-axle spacings such as 148×12 mm, 177×12 mm, and 197×12 mm through modifications in the motor stator support shaft length and flange-to-flange measurements.

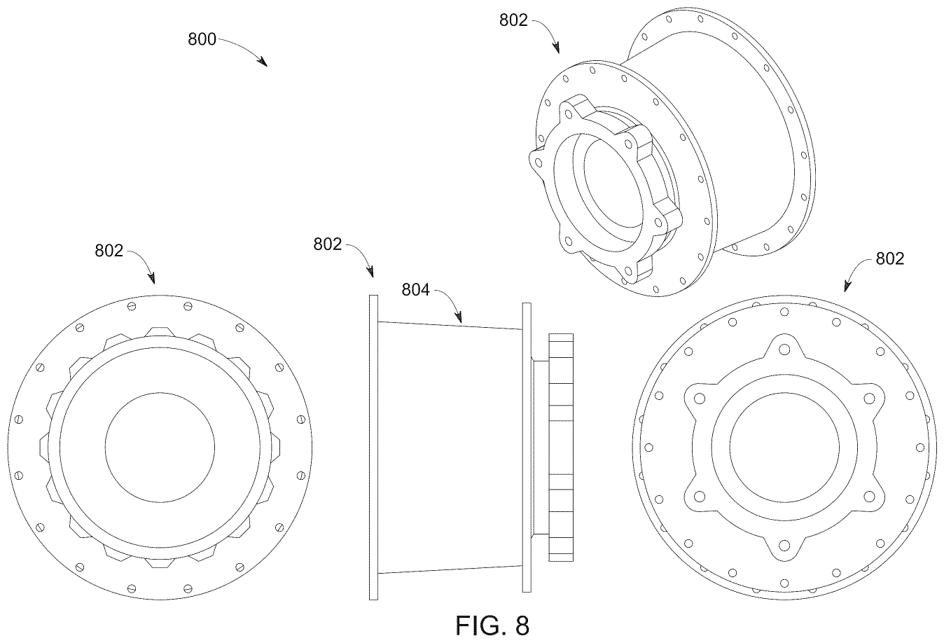

FIG. 8 is a diagram illustrating a detailed view of the Freehub Engagement Reaction Flange 800, showcasing its multiple functions, including the ratcheting mechanism interface and environmental sealing provisions. The rotor carrier body 802 features two key aspects: the non-drive side 804 with a 6-bolt disc brake rotor mount interface 806 having an approximately 83 mm bolt-circle-diameter (B.C.D.) 808, which may be a departure from the more common ISO 6-bolt 44 mm disc brake rotor mount interface, and the drive side 810 with a splined interface 812 for a rotor carrier reaction flange.

The 83 mm standard, derived from the Tektro-SR Suntour HESC hub motor brake mount, allows for the use of a larger outboard-mounted hub bearing seat 814, larger motor power-wire pass-throughs 816, and a stronger hub axle shaft region 818. The rotor carrier also contains a plurality of inwardly-facing semi-cylindrical splines 820 on the inside diameter for securing and angularly indexing the motor rotor assembly relative to the flange. In some embodiments, an annular groove 822 is formed adjacent the splined interface to receive one or more environmental sealing elements (such as an O-ring or elastomeric gasket), thereby inhibiting ingress of contaminants into the ratcheting mechanism or bearing cavity. Fastener apertures 824 are distributed circumferentially on the bolt circle to receive corresponding threaded fasteners or through-bolts for attachment to a brake rotor or reaction component.

In various embodiments, the Freehub Engagement Reaction Flange 800 may be formed as a single machined, forged, or molded component, or as an assembly of multiple pieces joined by welding, adhesive bonding, or mechanical fastening, and may be constructed from aluminum, steel, titanium, composite, or other structurally sufficient materials depending upon the desired weight, stiffness, and corrosion-resistance characteristics.

The reaction flange transmits both motor torque and rider-applied drivetrain torque into the hub shell body through a combined shear interface.

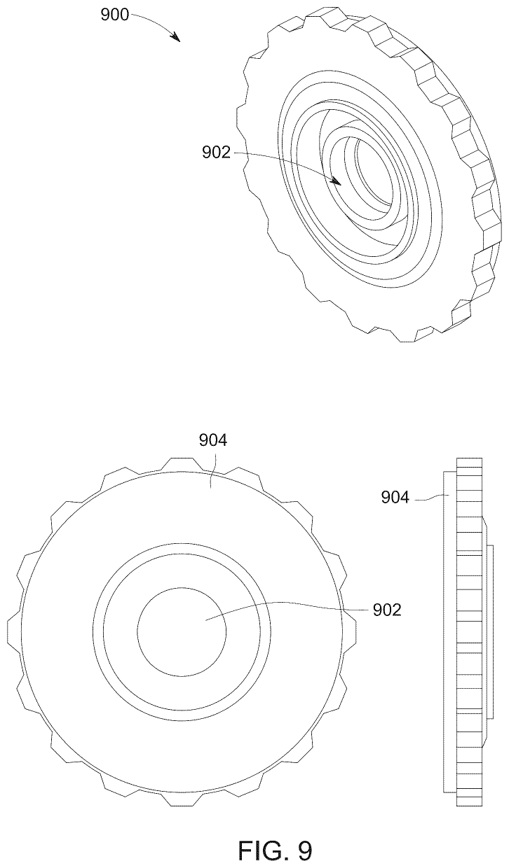

FIG. 9 is a diagram illustrating the Non-Drive Side End Cap 900, detailing its principal structural and functional features. The end cap 900 includes a central shaft-support bore 902 configured to receive and support a motor-stator support shaft 904, while simultaneously providing clearance for power and sensor cable pass-through 906 routed from the stator assembly. The outer flange portion 908 provides an interface for environmental sealing elements, such as an O-ring or gasket seated within an annular seal groove 910, thereby inhibiting the ingress of dirt, moisture, and road debris into the hub interior.

The Non-Drive Side End Cap 900 is formed as a homogeneous machined part and serves multiple functions within the hub-motor assembly. In addition to supporting axial and radial loads transferred from the rotor carrier assembly, the end cap also cooperates with the Freehub Engagement Reaction Flange 912 to complete the bearing stack-up and maintain precise axial alignment of the rotating components. The interlocking splines 914 on the engagement reaction flange 912 are configured at a predetermined spline angle 916 to allow thermally assisted interference fitting while minimizing radial bowing of the rotor carrier during high-torque or impact loading conditions.

In some embodiments, the Non-Drive Side End Cap 900 further includes an outer protective lip 918 extending axially beyond the seal groove 910 to act as a debris shield, and may optionally incorporate drainage or pressure-equalization features 920. The component may be formed of aluminum, steel, titanium, or composite materials depending on desired weight, strength, and corrosion-resistance characteristics.

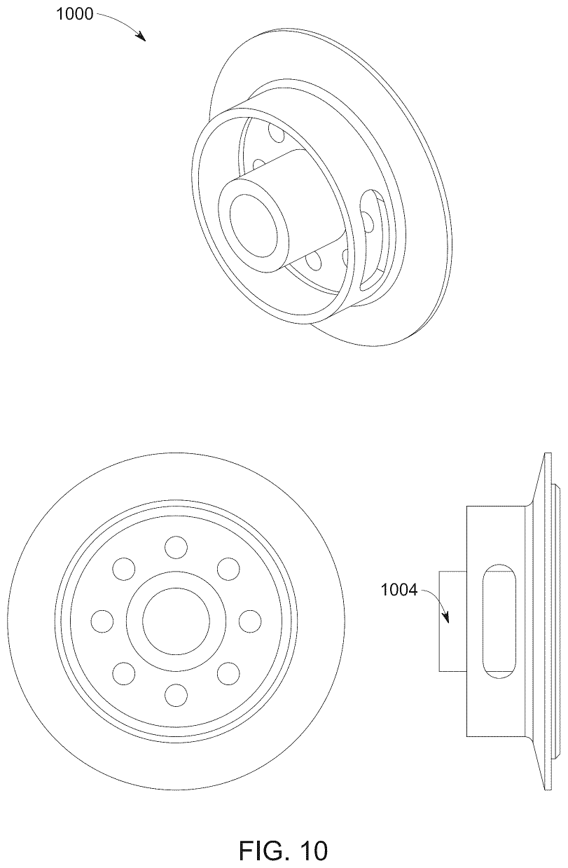

FIG. 10 is a diagram illustrating the motor rotor frame 1000, highlighting its construction using a fused filament deposition (FDM) printing media and its optimized filament deposition pattern. The motor rotor frame 1000 is implemented as a non-drive side end cap configured to enhance the functionality and protection of the hub motor assembly. The non-drive side end cap 1000 allows for the passage of power and sensor cables through an ovalized channel, supports the motor-stator support shaft via a central bore 1004 on the non-drive side dropout, and prevents rotation of the motor assembly. The end cap 1000 further serves to protect and seal the motor internals from dirt and grime. The ovalized channel may facilitate routing of sensor and power wires from the motor interior into a bicycle frame. A locking pin aperture 1006 may be positioned opposite the ovalized channel 1002 to receive a locking pin that prevents rotation of the end cap 1000 around the motor-stator support shaft. At a flange base of the non-drive side end cap 1000, a centering recess groove may be formed to accommodate a TEFLON (polytetrafluoroethylene (PTFE)) labyrinth packing seal, thereby enhancing rejection of water, dirt, and grime. In some embodiments, the FDM structure includes continuous fiber reinforcement, carbon-filled polymer, or glass-filled polymer layers oriented along principal stress axes.

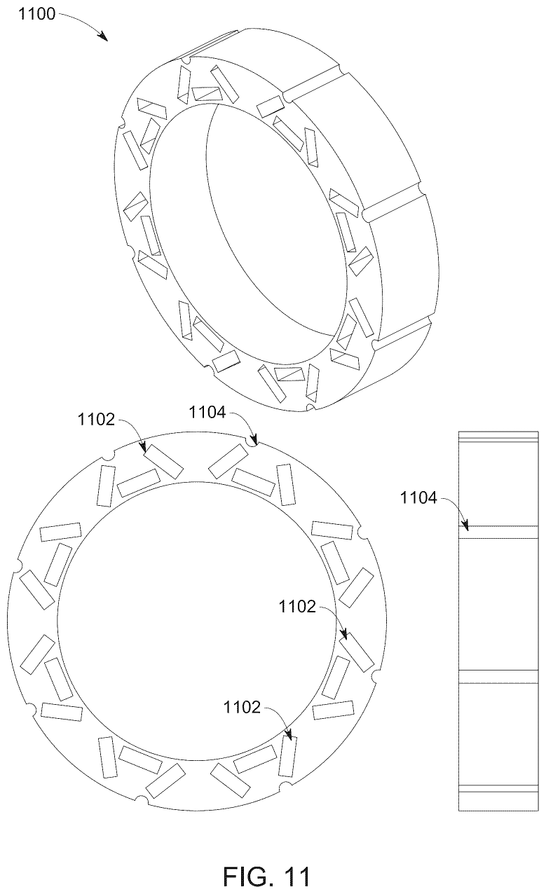

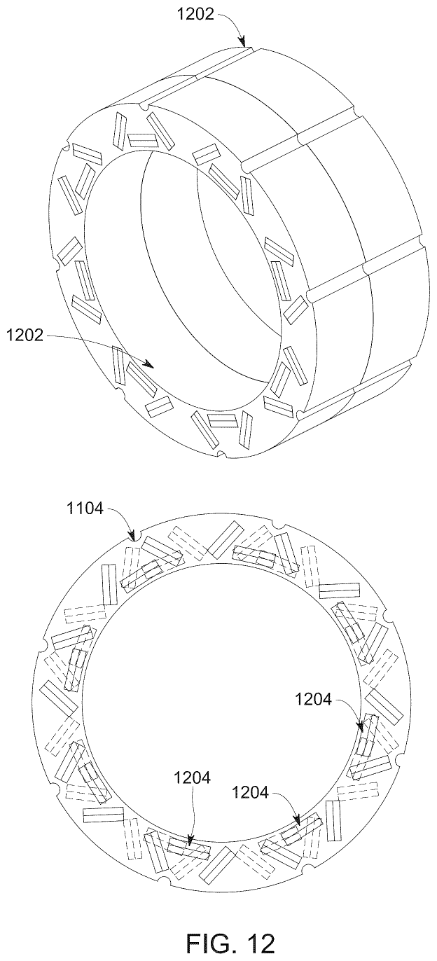

FIG. 11 is a diagram illustrating the motor rotor assembly 1100, showcasing the reluctance optimized Halbach array 1102 and the indexing notches 1104 for assembly alignment. FIG. 12 is a diagram illustrating the motor stator frame, featuring 24 T beam sections joined by an internally 6-splined disc and constructed using FDM printing including MOTOR ROTOR 1202 (e.g., MD-01954) and magnets 1204 (e.g., 20 mm×10 mm×3 mm). It will be understood that these are only examples.

FIGS. 11 and 12 are diagrams illustrating the motor rotor frame and motor rotor assembly. The motor rotor frame may be composed of a semi-homogenous ferromagnetic composite material, designed to align magnets in a flux path with an optimized orientation for reluctance characteristics. The construction utilizes fused filament deposition (FDM) printing media, oriented to align with the magnetic flux field lines. This optimized filament deposition pattern in the rotor frame's microlamination structure functions similarly to flux gates in a stamped electrical steel core, resulting in a rotor that may be lighter, has a flux direction bias optimized as grain-oriented electrical steel, and exhibits improved eddy current loss properties compared to traditional electric machine manufacturing methods. The motor rotor assembly incorporates a reluctance-optimized Halbach array with magnets positioned 60 degrees inward off-radial tangent, focusing the magnetic field towards the stator. The rotor may be constructed in two sections with a 10-degree rotational offset to minimize torque pulsation noise under load, which may be particularly crucial for direct drive, slow-spinning electric machines. Additionally, the motor rotor assembly features indexing notches offset at 5 degrees to align with the 10-degree rotational offset when assembled.

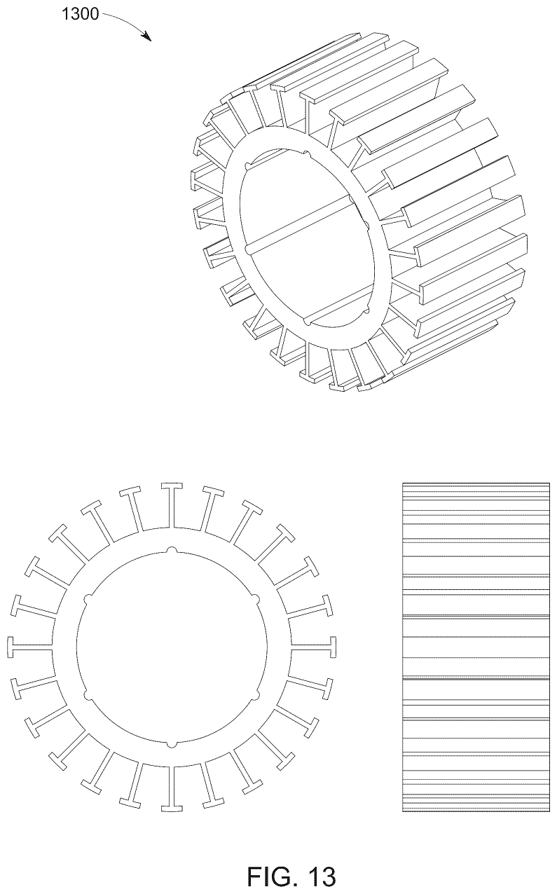

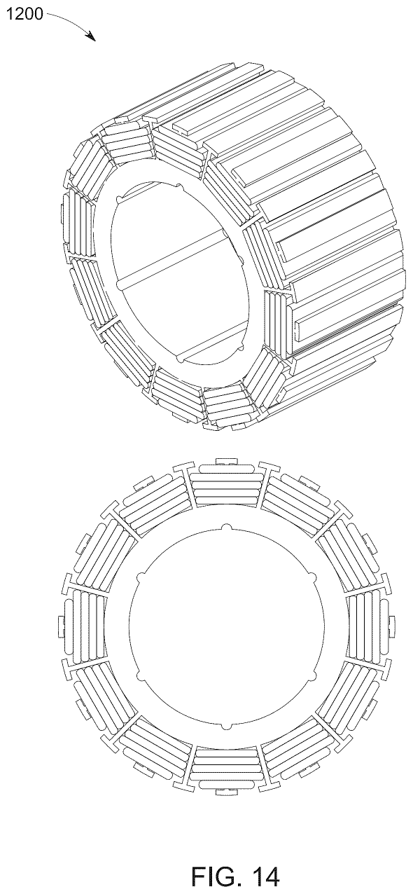

FIG. 13 is a diagram illustrating the completed motor stator assembly, with a 12-pole stator on a 24 T-beam frame and the coil out wire interconnects creating distinct magnetic engagement areas. FIG. 14 is a diagram illustrating a detailed view of the Motor Stator Support Shaft, showing its complex machined features, such as the splines to prevent rotation of the stator assembly and the port holes for wire pass-through, including left-hand wound copper wire 1402, right-hand wound copper wire 1404, and stator frame 1406.

FIGS. 13 and 14 are diagrams illustrating the motor stator frame 1300 and the completed motor stator assembly 1400. The motor stator frame may be an outrunner type with 24 T-beam sections connected by an internally 6-splined disc, manufactured using FDM printing with ferromagnetic thermoplastic filament to form a stack of microlaminations 0.2 mm thick. The filament deposition pattern may be optimized for conducting magnetic flux fields in a desired directional pattern, similar to flux gates, but with higher solidity, significantly lower eddy currents, and reduced inductive thermal buildup. The completed motor stator assembly features a 12-pole stator on a 24 T-beam frame, with T-beams between the windings forming intermediate poles to increase the magnetic engagement area and aid in magnetic field focusing between similarly polarized coils, thus reducing internal magnetic noise. The windings are wound in the same direction, but the polarization of the coil out wire interconnects creates an apparent Right Hand Wound 1402 and Left Hand Wound 1404 equivalent orientation. There are six separate coil pairs positioned 180 degrees from each other, with poles 1,7; 2,8; 3,9; 4,10; 5,11; 6,12. The stator assembly has six out wires, designated U, V, W, X, Y, Z, with a connection pattern that enables a 12-pole stator to control an 8-pole rotor while maintaining four distinct regions of magnetic flux: U(1,10); V(2, 11); W(3,12); X(4,7); Y(5,8); Z(6,9).

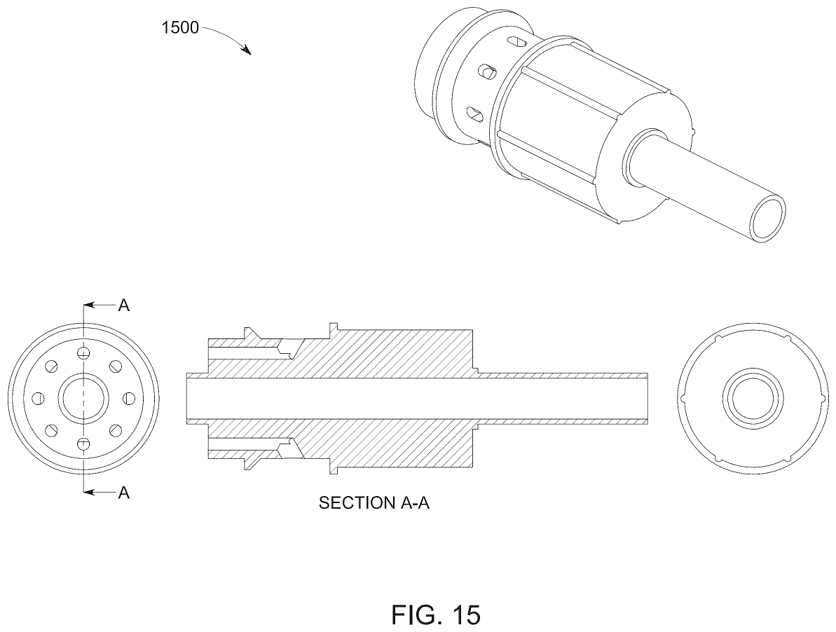

FIG. 15 is a diagram illustrating the freehub driver body 1500, highlighting its design to interface with various types of ratcheting mechanisms. In an example, this component features a complex machined 7050 anodized aluminum billet with a 12 mm wide hollow shaft running through the axle plane at the center. It includes a series of machined shoulders designed to support, via direct contact, various elements such as bearings, end caps, the freehub driver, the motor stator assembly, and consequently the rotor carrier and freehub engagement reaction flange. On the region where the motor stator assembly slides into, there are six, 2 mm radius splines matching the internal pattern of the motor stator frame to prevent rotation of the stator assembly about the motor stator support shaft when the motor-generator may be under load. Towards the non-drive side of the motor stator support shaft, eight axially drilled port holes with a 60-degree angle radial thru slot and an elongated circular entranceway allow the motor power wires and sensor wires to pass through from the inside of the rotor carrier to the outside of the hub motor assembly. On the drive side, the extended portion of the 12 mm I.D, 15 mm O.D. shaft supports the freehub engagement reaction flange bearing, freehub driver bearings, and driver body, as well as the drive side end cap. The length of this particular shaft section may be dependent on the specific stack length of the freehub driver, with a shorter shaft generally reserved for single speed specific applications. Most cassette freehubs are designed around a specific length used for 8/9/10/11/12 speed cassettes and are generally interchangeable.

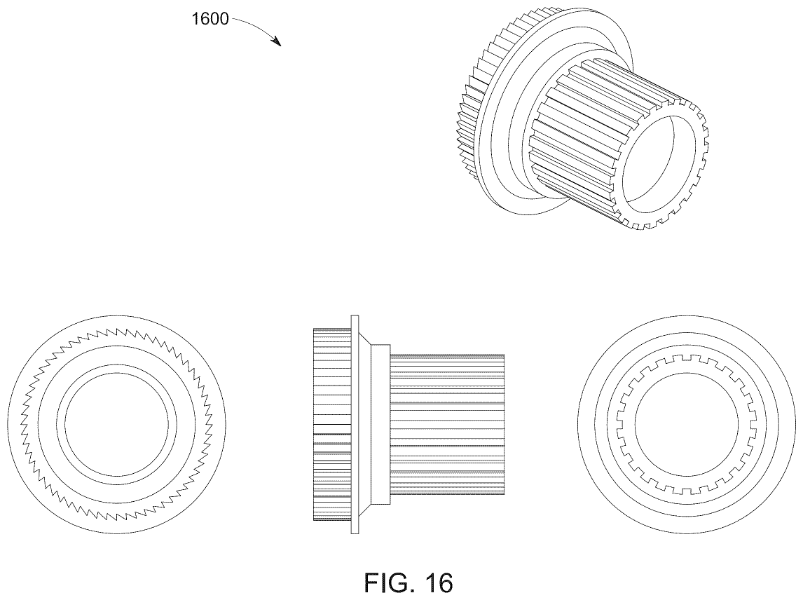

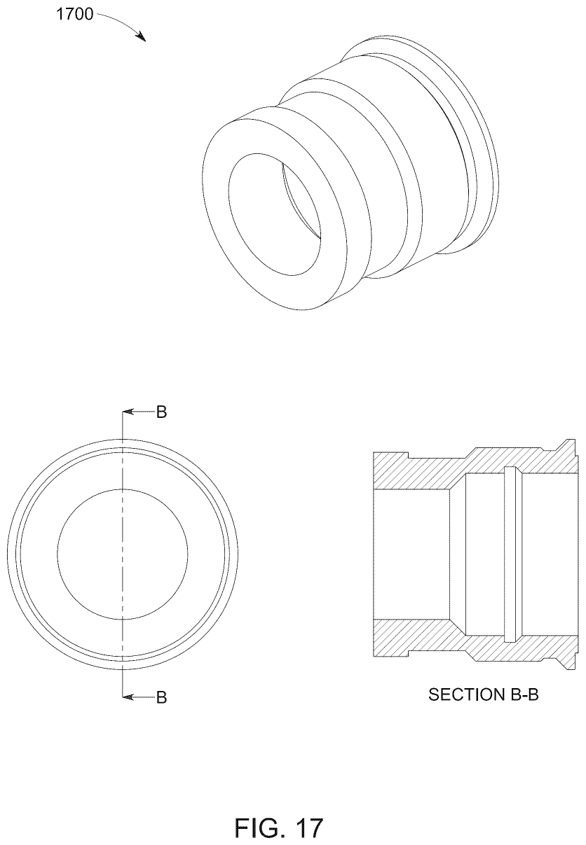

FIG. 16 is a diagram illustrating the drive side endcap 1600, illustrating its role in supporting the freehub driver body and providing environmental sealing. FIG. 17 is a diagram illustrating an individual machined part drawing of an alternative rotor carrier body 1700, demonstrating the use of a different type of rotor carrier spoke flange. The design of these components may be dependent on the specific cassette or rear sprocket standard used in the application. They are generally designed to interface with various types of ratcheting mechanisms, such as a ratcheting ring, internal/external pawl and ring gear, sprag clutch, or other unidirectional rotational locking mechanisms. As such, the depictions in these figures are representative and may vary based on the requirements of the particular hub motor assembly and the intended application.

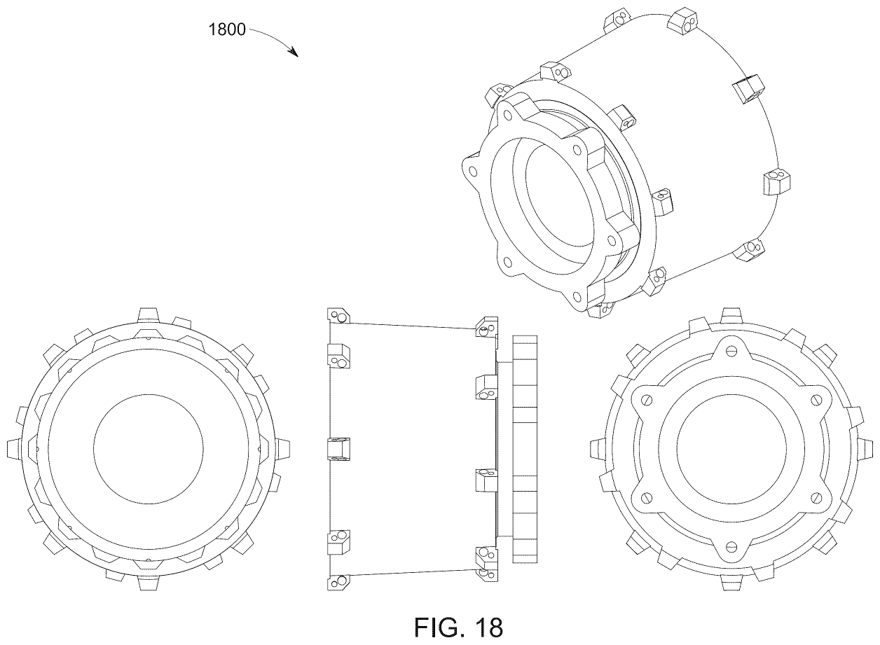

FIG. 18 is a diagram illustrating an individual machined part drawing of the rotor carrier body 1800, showing the 83 mm bolt-circle-diameter for the disc brake rotor mount interface and the splined interface for the rotor carrier reaction flange. Similar to FIG. 8, this rotor carrier body features a 6-bolt disc brake rotor mount interface with an 83 mm bolt-circle-diameter on the non-drive side and a splined interface for a rotor carrier reaction flange on the drive side. The larger bolt hole circle diameter facilitates the use of a more substantial outboard mounted hub bearing, enhanced motor power wire pass-throughs, and a more robust hub axle shaft. The internal structure of the rotor carrier includes eight semi-cylindrical splines for the secure placement and precise alignment of the motor rotor assembly.

### Bicycle and Hub Motor Interaction

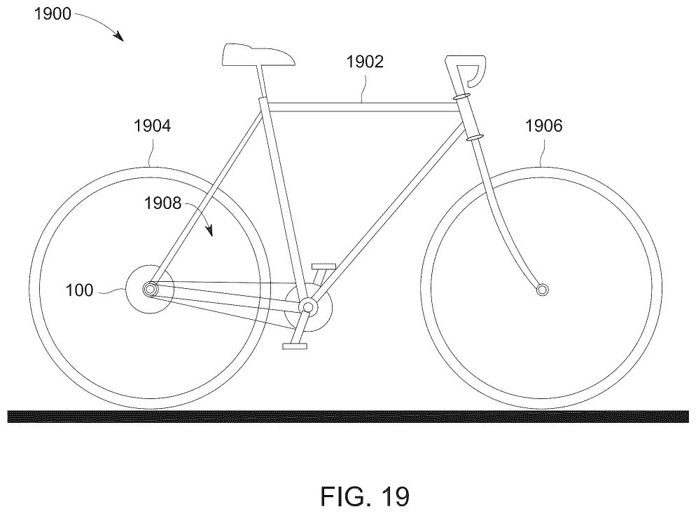

Disclosed in FIG. 19 is a bicycle 1900 including an integrated hub motor 100 as previously described in FIG. 1. The bicycle 1900 features a frame 1902, two wheels 1904, 1906, (although application to one-wheel devices and devices with three or more wheels are also contemplated) and a pedal system 1908 that may include including pedals, a chain, etc., operatively coupled to the hub motor 100. The hub motor 100 may incorporate a stator 104 constructed of laminated silicon steel and a rotor 106, as discussed with respect to FIG. 1.

The motor's torque delivery may be optimized based on pedal input, utilizing integrated accelerometers and gyroscopes for predictive terrain adjustments. Riders can select between variable pedal assistance levels via a user interface. Further integration includes a battery management system (BMS) capable of managing cell voltages, monitoring battery health, calibrating discharge rates, and enhancing battery lifespan. The hub motor 100 may be designed to handle challenging terrains, maintaining functionality under wet and muddy conditions. Additionally, a control interface provides access to ride analytics, GPS navigation, and motor tuning options. In summary, the disclosed hub motor and integrated bicycle provide a comprehensive solution for enhanced electric-assisted cycling, combining advanced motor technology with efficient design elements for improved efficiency, torque, and overall rider experience.

When integrating the hub motor into a bicycle, it becomes a part of an e-bicycle system. This bicycle may be designed for versatility, safety, and optimized performance, especially in off-road terrains. The bicycle, which may be structured around the hub motor, may, for example, use a 12 mm through axle as the bicycle's drive wheel securing system. This system may be tailored to offer safety and sturdiness, especially when navigating rough terrains.

When engaged, the hub motor may receive signals from various sensors and controllers on the bicycle. There might be a crank-mounted cadence counter, which can be instrumental in activating the power assist. This power assist may ensure that the rider does not exert too much force, especially during uphill rides or challenging terrains.

For precision control and enhanced user experience, there may be a human-machine interface on the bicycle. This interface may allow riders to turn on/off the motor assist system, adjust settings, and even view battery charge status. The bicycle may also offer built-in diagnostic tests for the bicycle's electronic and mechanical systems.

A unique interaction may be the potential wireless communication between the hub motor and a crank-mounted strain gauge. This gauge may measure the force applied to the bicycle's pedals, thereby modulating the motor's torque accordingly to potentially ensure the motor provides just the right amount of assist, making rides smoother and more enjoyable.

Furthermore, the bicycle may be designed to utilize the hub motor's regenerative braking system. When coasting or descending, the hub motor may act as a generator, converting some of the kinetic energy back into stored electrical energy. This not only conserves battery life but may also provide rear-biased speed control, which may help ensure safety during downhill rides.

In summary, the bicycle and hub motor's interaction may be harmonious, with both components working in tandem to offer riders an efficient, safe, and enjoyable riding experience. Whether one is cruising through city streets or navigating challenging terrains, this combined system is designed to handle it all.

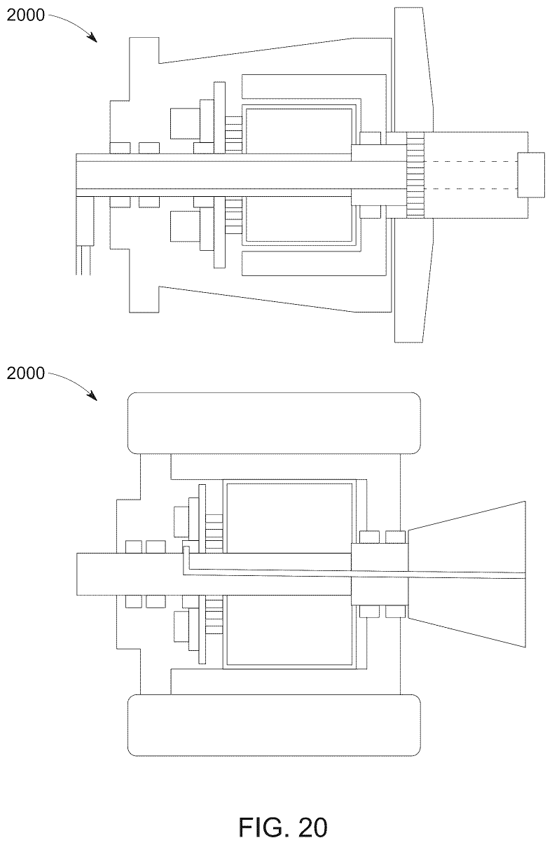

FIG. 20 is a diagram illustrating another example embodiment of a hub motor 2000. The hub motor 2000 includes a hub shell body 2002, a six-phase motor coil driver PCB 2004, and a motor dash stator support shaft 2006. The hub motor 2000 also includes a 12 millimeter through axis compatible shaft 2008. It will be understood however that other shaft sizes are possible based on other bicycle standards, for example. The hub motor 2000 includes a power and CAN-bus connector 2010 in the illustrated embodiment. Additionally, the hub motor 2000 includes a hub-shell reaction flange 2012. Optionally, the hub motor may include a free hub body 2014 and end cap 2016.

The motor stator support shaft 2006 may be designed with specific considerations for integration into a skating system. It may be machined as part of a skate truck. This integration approach may offer potential advantages, such as streamlined assembly and potentially simplified maintenance. Additionally, by incorporating the support shaft directly into the skate truck, it may allow for certain design efficiencies in terms of space utilization and alignment. The combination may also result in a potential reduction in the number of separate components, which in turn might benefit the overall manufacturing process. As the design is considered, choices regarding materials and machining processes may play a role in achieving desired characteristics for the integrated structure.

In the illustrated example of FIG. 20 the hub reaction flange 2018 may be screwed and/or press fit to the rotor 2020. The rotor 2020 may be a cast-on rotor 65A Duro polyurethane wheel dash tire. FIG. 20 also illustrates power and CAN-Bus routing 2024. In other embodiments, additional driver phases may be electrically emulated by time-offset commutation sequencing rather than by physical duplication of stator windings.

The illustrated embodiments employ a freehub driver interface rather than a threaded freewheel interface.

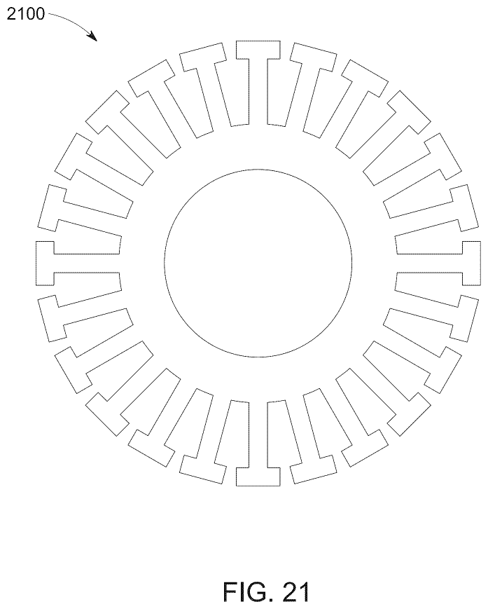

FIG. 21 is a diagram illustrating an example stator core pattern 2100. The stator core is a component of electric machines, typically made of laminated iron, which may provide a path for the magnetic field. (The stator core may provide mounting positions for the magnets, e.g., of an electric motor.) Proper design and configuration of the stator core may be needed for efficient magnetic field generation.

In some embodiments, the stator may be a stationary part of an electric motor. Comprised of laminated metal with wire coils, the flow of current through these coils may produce a magnetic field that interacts with the rotor, inducing its movement. The stator's configuration can play a role in influencing the motor's overall performance.

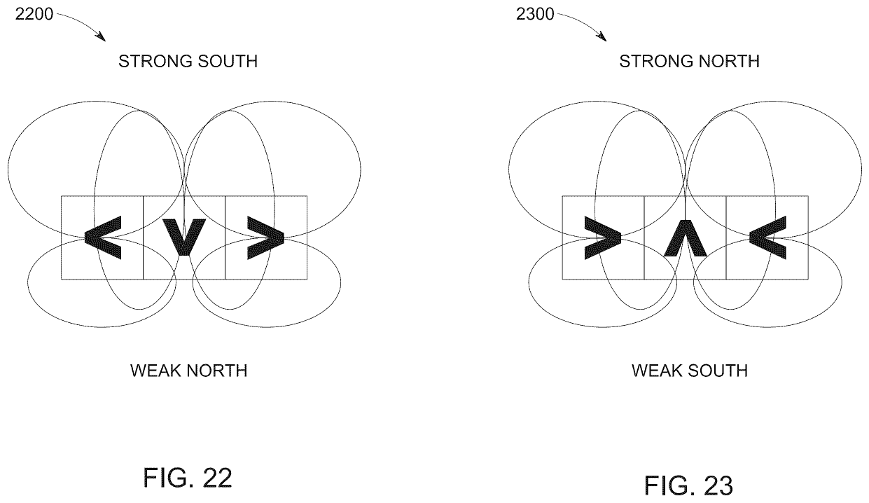

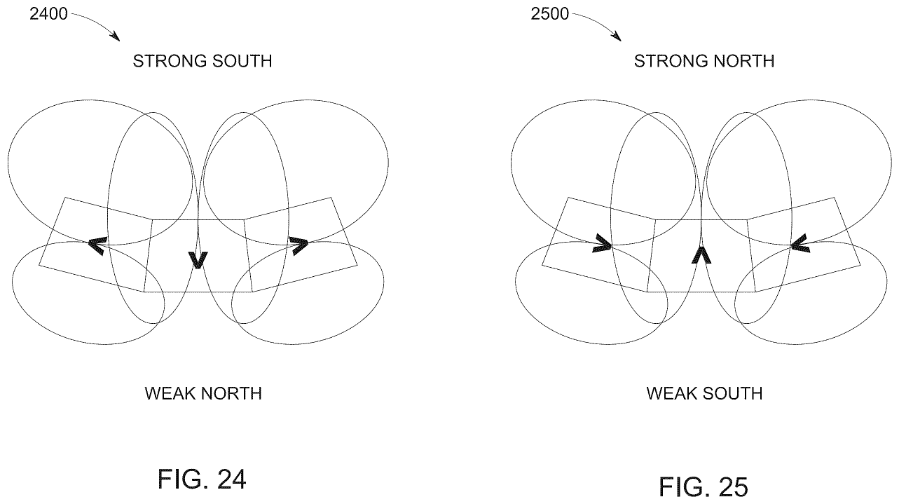

FIGS. 22-23 are diagrams illustrating examples of a strong south magnetic field and weak north magnetic field 2200 and a weak south magnetic field and strong north magnetic field 2300 using one example magnet layout. Magnetic fields play a role in the operation of electric machines, generating the necessary force to move the rotor. The arrangement of north and south poles can influence the motor's torque and speed characteristics. FIGS. 24-25 are diagrams illustrating examples of a strong south magnetic field and weak north magnetic field 2200 and a weak south magnetic field and strong north magnetic field 2300 using one example magnet layout (with curved magnets). Alternative layouts can be used to achieve specific performance characteristics or to overcome design constraints in certain applications. FIGS. 22-25 present the differences in magnetic fields resulting from varying magnet layouts. These differences can affect how electric machines perform. The way the north and south poles are arranged may change the machine's power and speed. Fine-tuning this layout helps meet different needs and improve the machine's overall function.

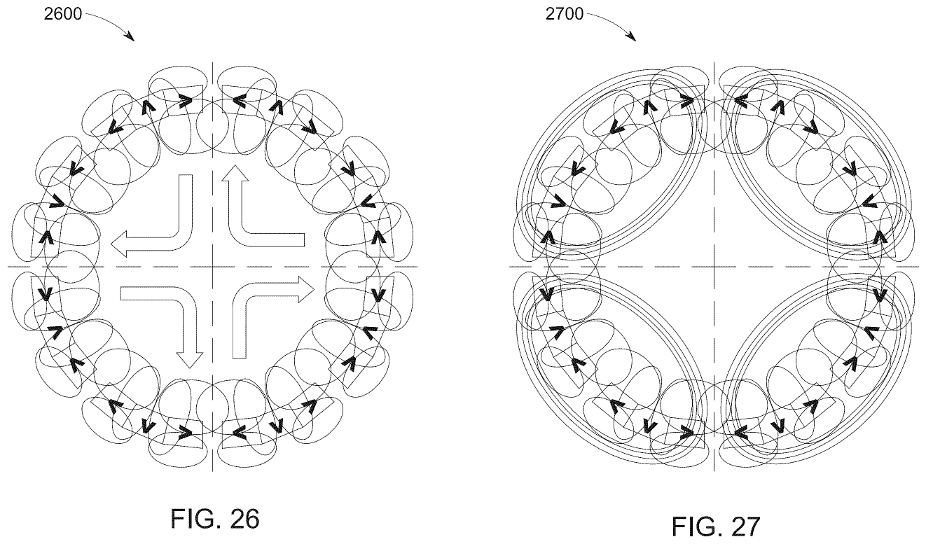

FIGS. 26-27 are diagrams illustrating magnetic field lines along a rotor 2600, 2700. The rotor's role is to respond to the magnetic fields generated by the stator, resulting in rotational motion. Its design can influence efficiency, torque, and other performance metrics. FIGS. 26-27 illustrate how magnetic field lines interact along a circular rotor in a motor setup. The manner in which these field lines envelop the rotor may influence how effectively the motor operates.

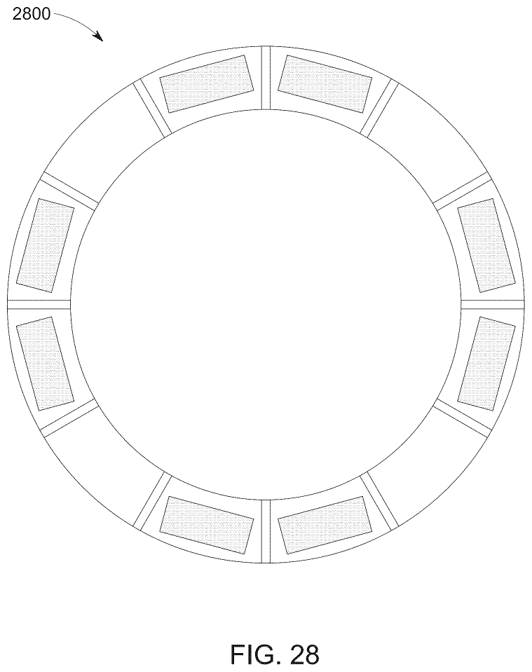

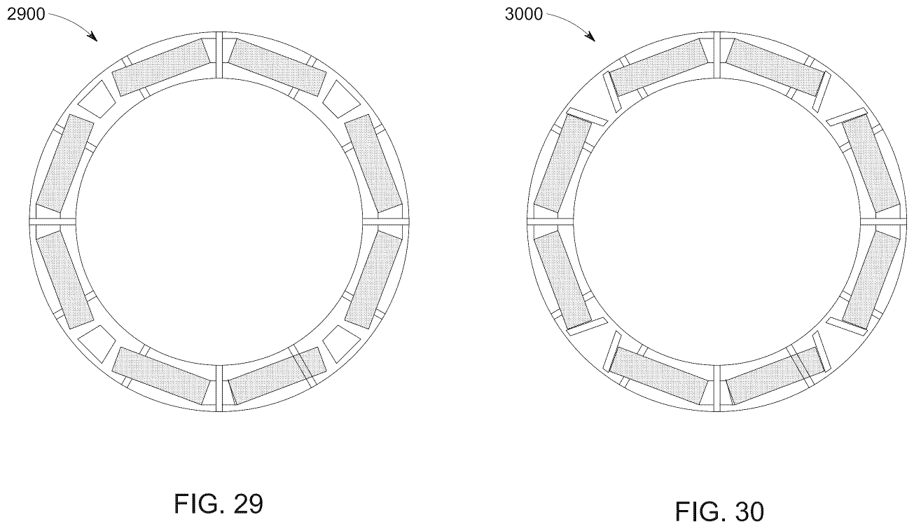

FIGS. 28-30 illustrate examples of rotors 2800, 2900, 3000. FIGS. 31-32 also illustrate examples of rotors 3100, 3200. Generally, rotors may be central components in motors that rotate in response to electromagnetic fields. Depending on the specific application and requirements, rotors can be designed in multiple ways. The choice of rotor design can affect the performance, efficiency, and longevity of a motor. The rotor may play a pivotal role in converting electrical energy into mechanical motion. Rotors may come in various designs, such as squirrel cage or wound types, each with its advantages and application-specific benefits. Different rotor designs may be optimized for various operational conditions like high-speed operation or high-torque demands.

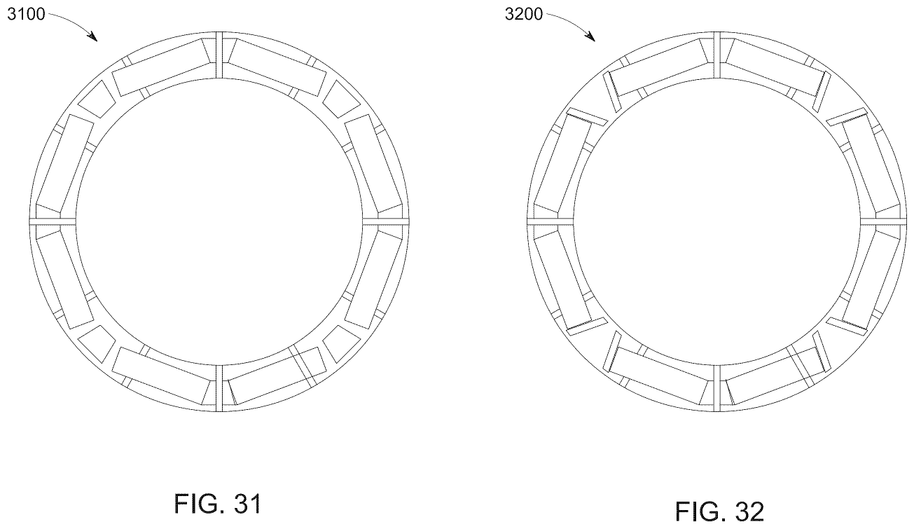

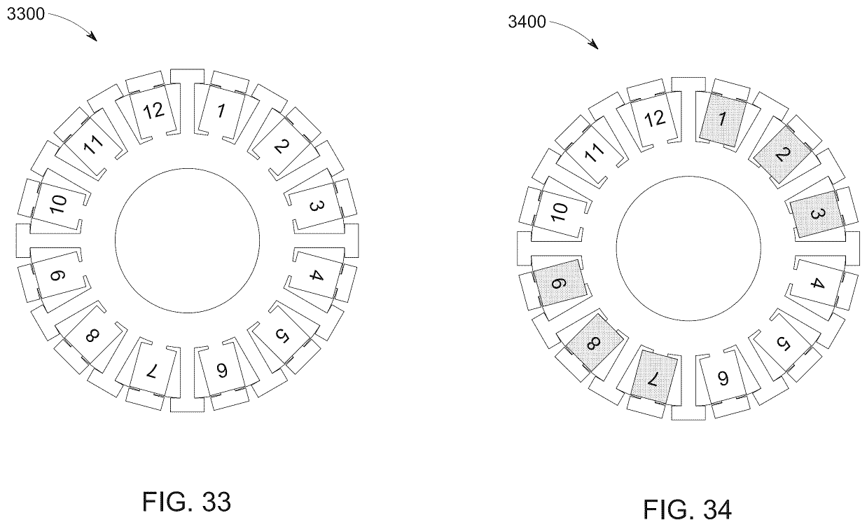

FIGS. 33-34 illustrate a stator core with a series of coils 3300, 3400. Coils in the stator generate magnetic fields when current flows through them. Their placement, winding, and design can influence the magnetic field's strength and direction. The stator may be a stationary counterpart to the rotor in a motor. The stator 3500, 3600, 3700 may comprising multiple coils, the stator creates an environment where controlled magnetic fields 3602, 3702 emerge, as illustrated in FIGS. 35, 37, and 38. When electric current is passed through the coils, the current may produce magnetic fields, which then interact with the rotor. The arrangement and design of these coils within the stator may ensures that the magnetic fields generated are both effective and efficient in driving the rotor, which in turn may affect the overall performance of the motor. The stator, through the stator's coils, may set the stage for the rotor's movement and the motor's functionality.

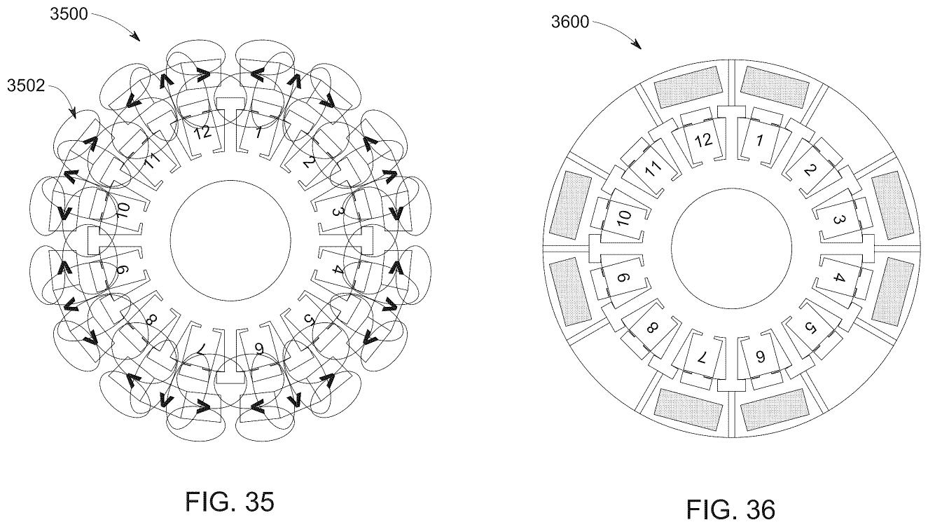

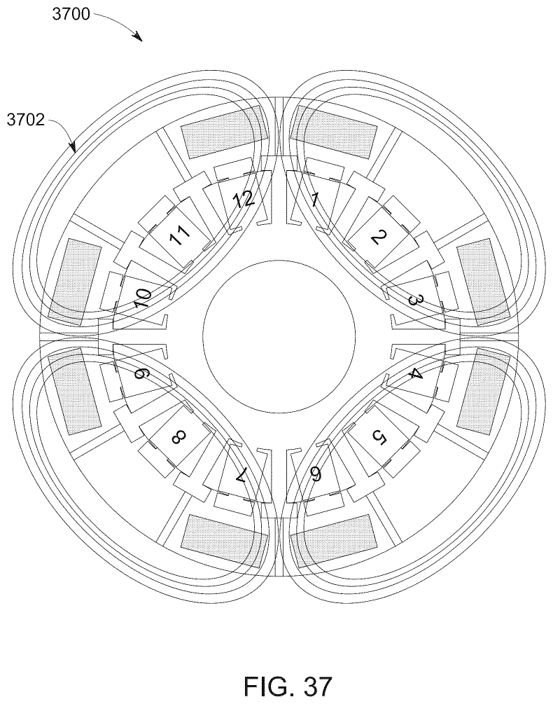

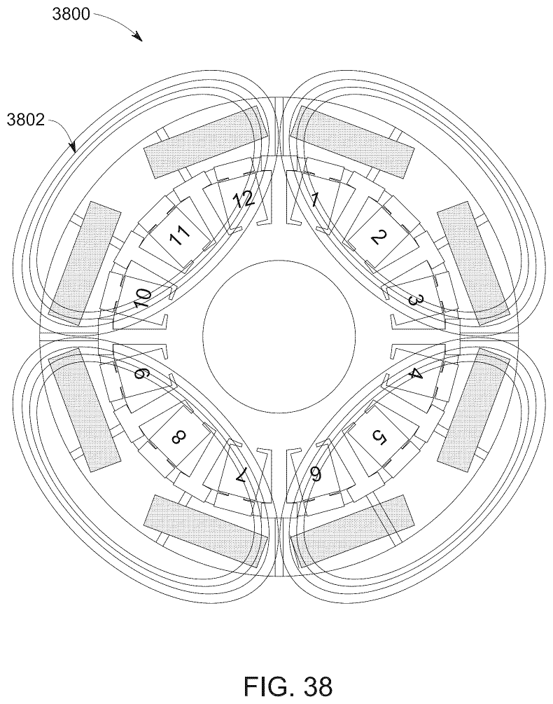

FIG. 35 illustrates a stator core with coils inside a rotor. This configuration can be seen in certain motor designs where the stator is internal, and the rotor surrounds it. FIG. 36 provides a detailed view of the stator core and coils inside a rotor. Understanding the physical connections between the stator and rotor may be used for predicting motor behavior and optimizing performance. FIG. 37 emphasizes the electromagnetic aspects of a stator core with coils inside a rotor. Magnetic field lines indicate the path and intensity of magnetic force, which drives the rotor's motion. Stator 3800 of FIG. 38 focuses on the magnetic field lines 3802 and their variations during operation. Changing magnetic fields, achieved by altering current in the coils, results in continuous rotor movement.

This internal stator configuration, with its coils enveloped by the rotor, may offer certain advantages. In some embodiments, the configuration may lead to improved heat dissipation, as the rotor's movement can facilitate better air circulation around the stator coils. Moreover, having the stator inside may also result in a more compact motor design, potentially making it suitable for applications with space constraints. The interplay between the stator and rotor, especially in this unique configuration, underscores the importance of precision in design and assembly. Ensuring that the coils are optimally positioned, and wound may help achieve desired motor characteristics, such as efficiency, torque, and speed.

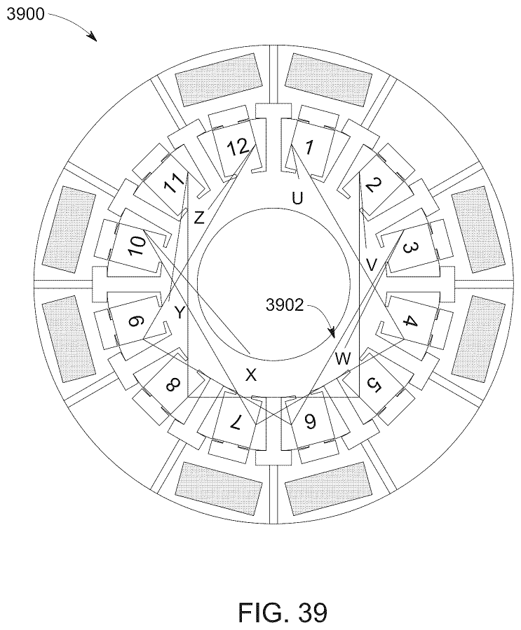

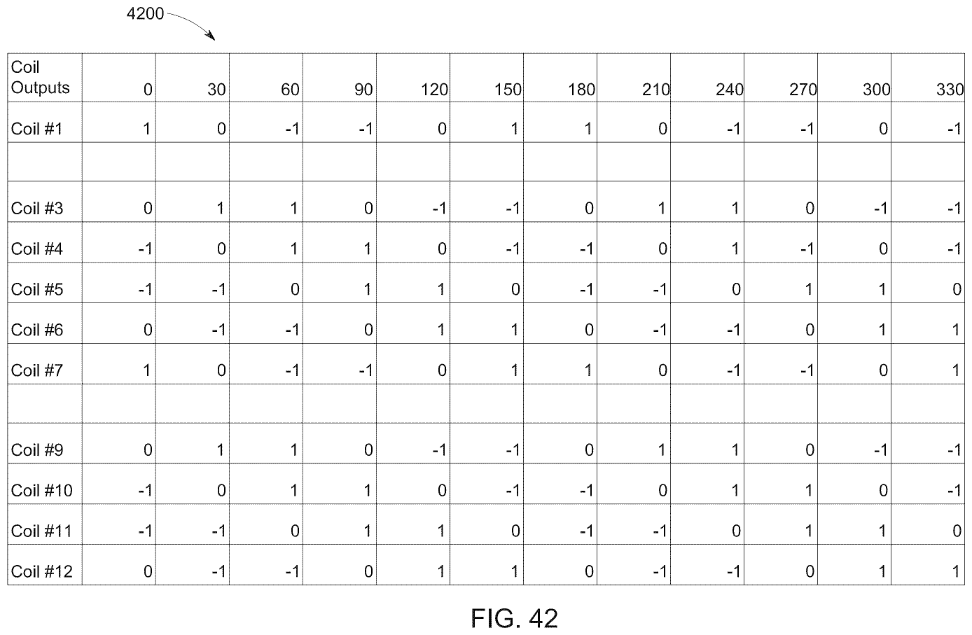

FIG. 39 illustrates a stator core with coils within a rotor 3900, detailing the sequence of coil activations 3902. Sequential activation can be used to control rotor position, speed, and direction. An example sequential of activation is illustrated in FIG. 42.

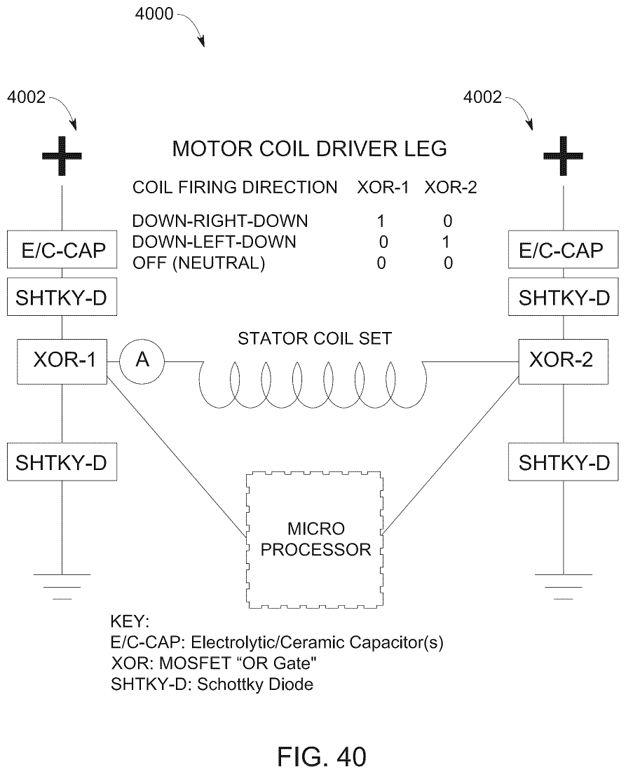

FIG. 40 illustrates an example motor coil driver leg 4000. Coil drivers 4002 are electronic components that supply current to the motor coils. Proper driving may provide for efficient motor operation and control. The motor coil driver leg pair configuration. The driver leg pair consists of two distinct legs. Each leg begins with a positive voltage, followed sequentially by an electrolytic and/or a ceramic capacitor to stabilize the input voltage, followed by a Schottky diode, an XOR gate, and then another Schottky diode. Situated between the XOR gates of each leg is a stator coil, serving to drive the motor that the motor coil driver leg may be installed in. A microprocessor is illustrated as being coupled with each XOR gate, such that the microprocessor may control the behavior of the XOR gates, providing a layer of control or modulation over the motor's coil energization. For example, the microprocessor may control the coil firing direction. In the example embodiment illustrated in FIG. 40, the coil firing directions for the XOR-1 and XOR-2 gates are distinctly illustrated as: DOWN-RIGHT-DOWN (with a logic state of 1 0), DOWN-LEFT-DOWN (with a logic state of 0 1), and an OFF or NEUTRAL state (with a logic state of 0 0). These sequences may indicate specific energization patterns or behaviors imparted upon the connected motor, ultimately influencing its rotational characteristics or stationary states. It will be understood that other example coil firing directions are possible and would be understood by those of skill in the art, after reviewing the instant application.

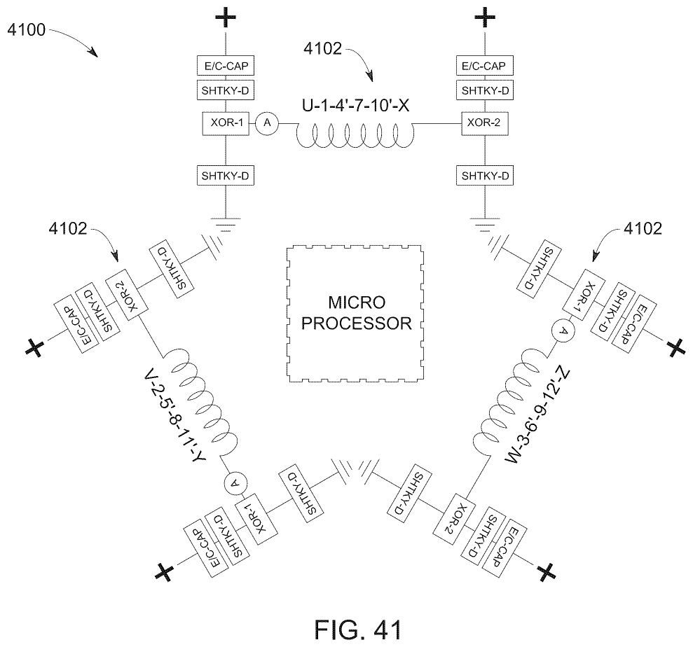

FIG. 41 illustrates a motor coil driver circuit 4100 with three sets of motor coil driver legs 4102. Multiple driver legs can be used to drive multiple coils, offering refined control over the motor's movement. Building on the discussion of FIG. 40, FIG. 41 extends the concept by illustrating a motor coil driver circuit incorporating three motor coil driver legs. Such a design allows for a more intricate interfacing with multiple coils, thereby granting the capability for nuanced manipulation over the motor's operations. The integration of multiple legs may be pivotal in ensuring smoother transitions, enhanced efficiency, or more precise movement sequences within the motor mechanism.

FIG. 42 illustrates the firing order 4200 of a motor coil driver circuit. The firing order determines the sequence in which coils are energized, which in turn affects the rotor's motion and direction. The sequence in which the coils are energized directly correlates with the rotor's movement and direction. Adjusting this sequence may alter the motor's behavior to fit specific operational needs. The firing order not only determines the immediate rotor movement but also has implications on efficiency and torque.

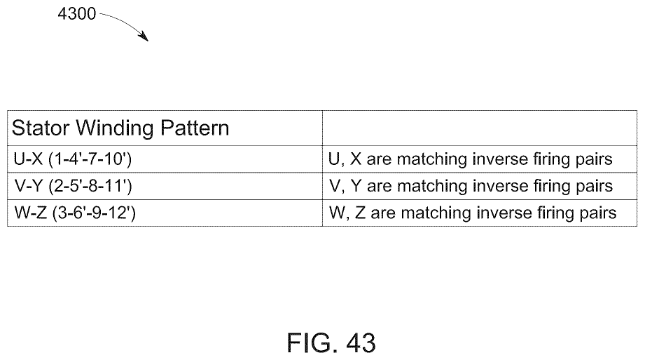

FIG. 43 illustrates a stator wiring pattern 4300 that may be used for a single rectifier leg and its components. Rectifiers may be used to convert AC to DC, ensuring the motor receives the correct type and direction of current. FIG. 43 presents a stator winding pattern that hinges on the systematic coordination of firing pairs. In an embodiment, this pattern encompasses the firing pairs U-X, V-Y, and W-Z. Each pair displays a distinct sequence of coil activations. Specifically, the U-X pairing follows a 1-4′-7-10′ sequence, V-Y operates on a 2-5′-8-11′ sequence, and W-Z adheres to a 3-6′-9-12′ sequence. Notably, these pairs operate as matching inverse firing pairs. This means that when a coil in one pair is active, its counterpart remains passive. By adopting this winding and firing strategy, the stator may consistently generate balanced magnetic fields, enhancing the motor's efficiency, torque delivery, and overall performance.

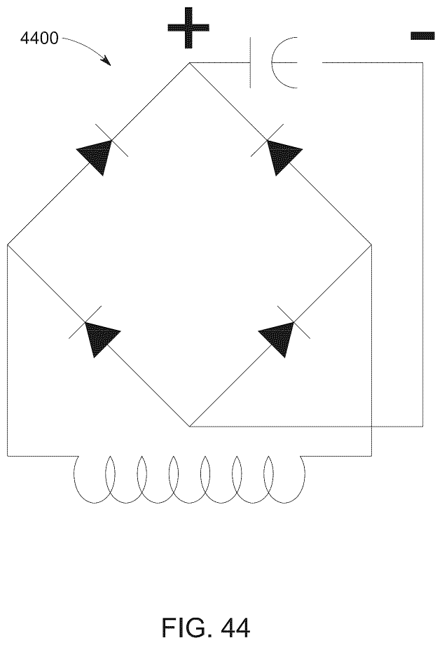

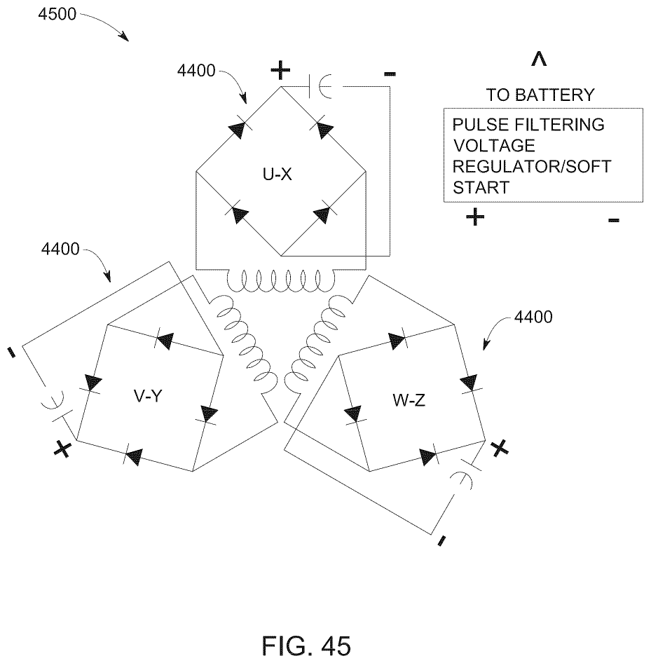

FIG. 44 illustrates single rectifier leg 4400 that may be used for a full motor rectifier circuit made of three interconnected rectifier legs. Multiple legs in a rectifier can handle higher current loads and offer more consistent DC output. FIG. 45 depicts a full motor rectifier circuit comprising three interconnected rectifier legs. In an embodiment, these legs form part of a bridge rectifier constructed with four diodes, systematically arranged to allow for efficient conversion of alternating current (AC) to direct current (DC). Connected across the bridge rectifier is a coil, which may serve to induce and modulate the magnetic field within the circuit. Additionally, a capacitor is positioned on opposing legs of the rectifier, potentially providing a mechanism to smooth the output voltage, ensuring a steadier and more consistent DC output. This design may be advantageous in managing higher current loads, contributing to the reliability and stability of the motor's electrical supply.

FIG. 45 displays three rectifier legs in a motor rectifier circuit 4500. The arrangement and interconnections between these legs may be for the rectifier's overall efficiency and reliability. FIG. 45 further illustrates three rectifier legs in a motor rectifier circuit, emphasizing their arrangement and the interconnections that contribute to the rectifier's overall efficiency and reliability. Additionally, a series of battery connections are presented, arranged between the positive (+) and negative (−) terminals. These connections may serve as a power source or backup, ensuring a consistent and stable voltage supply to the circuit. This integration potentially enhances the circuit's resilience to fluctuations or interruptions from external power sources, underscoring a design intent for continuous and efficient motor operation in varied scenarios.

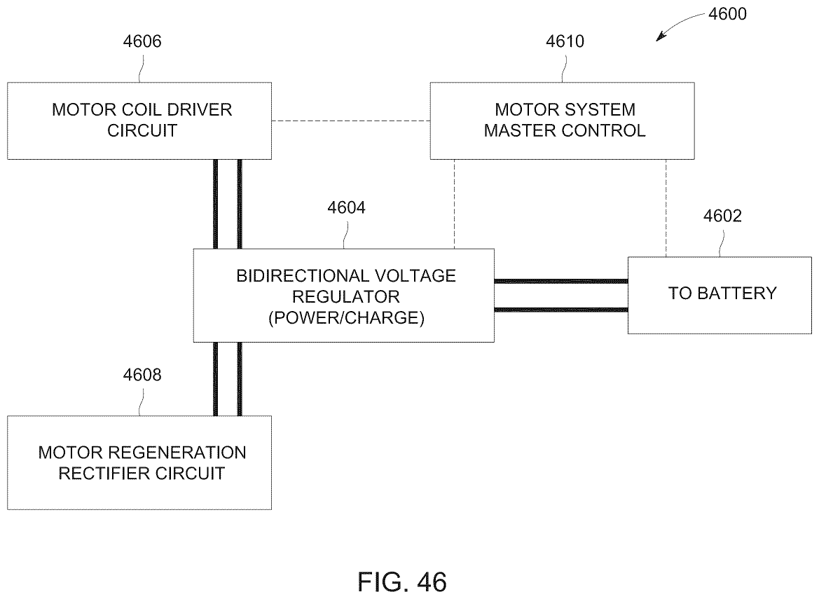

FIG. 46 is a block diagram 4600 illustrating an example motor system. The block diagrams provide an overview of the main components and their interconnections in a system, offering a high-level understanding of its operation. In the illustrated example embodiment of FIG. 46, the block diagram presents a motor system including a battery 4200, which may be the primary energy source. The battery may be electrically connected to a bidirectional voltage regulator 4404 which may regulate power to various other system components and/or charge back to the battery. For example, the bidirectional voltage regulator may have a power connection that extends to a motor coil driver circuit 4606 (e.g., see motor coil driver circuit FIG. 41 and motor coil driver leg FIG. 40) and to a motor regeneration rectifier circuit 4608 (e.g., see motor rectifier circuit, FIG. 45 and single rectifier leg, FIG. 44), facilitating the flow of energy throughout the system. Overseeing and managing the flow of power and signals may be a motor system master control 4610. The motor system master control may send control signals to the battery, the motor coil driver circuit, and/or the bidirectional voltage regulator, to provide cohesive operation and improve performance across all components.

These figures are provided to illustrate and explain the concepts of the invention. It should be noted that they are not exhaustive and other configurations and embodiments are possible within the scope of the invention.

In example embodiments, an electric hub motor system includes a stator assembly, a rotor assembly circumscribing the stator assembly, a motor-stator support shaft, a hub-shell reaction flange, a hub shell body, and associated bearings, seals, and electrical interfaces. The hub motor is configured to transmit torque directly to a wheel through the hub shell body without an intermediate chain, belt, or shaft drive mechanism.

In some embodiments, the hub motor is configured for compatibility with a thru-axle mounting system. The thru-axle may pass through a central bore of the motor-stator support shaft and engage threaded retainers or dropouts on a supporting frame. The hub motor assembly may be dimensioned to accommodate multiple thru-axle standards by varying shaft length, spacer placement, or flange spacing.

The hub shell body may include spoke flanges configured for straight-pull or J-bend spokes and may support 28-hole, 32-hole, or other spoke counts. The hub shell body may further include a disc brake mounting interface, such as a multi-bolt interface or other standardized brake attachment format.

### Motor Configuration

In example embodiments, the hub motor employs a synchronous permanent magnet brushless direct current outrunner configuration. The rotor circumscribes the stator and rotates about an external diameter of the stator.

The stator may include a plurality of stator poles formed from laminated electrical steel, microlaminated composite material, or ferromagnetic composite thermoplastic material. The stator may be constructed using additive manufacturing, lamination stacking, stamping, or hybrid manufacturing techniques.

The stator may include a plurality of stator windings arranged in coil groups. In some embodiments, the stator includes six physical output conductors. Through selective commutation and firing sequences, the stator may electrically emulate a greater number of phases, such as 6-phase, 9-phase, or 12-phase operation. This phase emulation enables improved torque density, smoother torque delivery, and reduced torque ripple while limiting conductor count.

The stator windings may be driven using an inverse common polarity principle in which paired windings are alternately energized with opposing polarities to form apparent multi-phase groupings.

### Rotor Assembly

The rotor assembly may include a rotor frame supporting a plurality of permanent magnets. The magnets may be arranged in a Halbach array or other magnetization pattern to reinforce magnetic flux toward the stator while reducing stray flux on the opposite side.

In some embodiments, the permanent magnets are positioned at an angular offset relative to a radial tangent of the rotor circumference. This off-radial-tangent magnet positioning improves magnetic field focusing toward the stator and contributes to reluctance tuning of the magnetic circuit.

The rotor frame may be formed using a ferromagnetic composite thermoplastic material deposited using fused filament deposition or other additive manufacturing techniques. The filament deposition pattern may be oriented to guide magnetic flux along predefined paths, forming a flux gate pattern that reduces eddy current losses and magnetic hysteresis losses.

In some embodiments, the rotor assembly includes indexing features that ensure angular alignment between rotor sections, magnet groups, or rotor carrier components.

### Reaction Flange and Freehub Interface

In example embodiments, a hub-shell reaction flange is positioned between the rotor assembly and a freehub cassette driver. The reaction flange is configured to receive combined torque from both the motor rotor and the freehub cassette driver and transmit the combined torque to the hub shell body.

The reaction flange may include splined, keyed, or other torque-transmission interfaces. The reaction flange may further include bearing support surfaces and environmental sealing interfaces.

The freehub cassette driver may be inserted coaxially with the motor-stator support shaft and secured using press-fit, thermal press-fit, threaded fastening, or other attachment techniques. The freehub cassette driver may be interchangeable to accommodate multiple cassette standards.

The reaction flange may be formed as a single machined component or as an assembly of multiple joined components. Materials may include aluminum alloys, steel alloys, titanium alloys, composites, or combinations thereof.

### Support Shaft and Bearing Stack

The motor-stator support shaft may be formed from a non-magnetic, high-strength material such as aluminum alloy, stainless steel, or titanium. The support shaft may include splines or anti-rotation features that engage corresponding features in the stator frame to prevent stator rotation.

The support shaft may include internal passages for routing power conductors and sensor conductors. These passages may be oriented axially, radially, or helically.

Bearings may be positioned along the support shaft to support radial and axial loads generated during operation. Bearings may include ball bearings, roller bearings, thrust bearings, or combinations thereof. Spacers and washers may be used to establish proper bearing preload and axial alignment.

Environmental sealing elements such as O-rings, labyrinth seals, or lip seals may be positioned between rotating and stationary components to inhibit ingress of moisture, dust, and debris.

### Electrical Architecture

In example embodiments, the hub motor includes integrated commutation circuitry located within the hub motor assembly. The commutation circuitry may include motor coil driver circuits, rectifier circuits for regenerative braking, voltage regulation circuits, and control logic.

The motor may include six power output conductors and multiple sensor conductors. Sensor conductors may carry signals from temperature sensors, position sensors, speed sensors, or other monitoring elements.

A motor master controller may be located within the hub motor or external to the hub motor. The motor master controller may communicate with a human-machine interface through a wired or wireless communication bus.

Control functionality may be distributed across multiple controllers or consolidated within a single controller depending on application requirements. In some embodiments, motor control, battery management, and user interface processing are performed by separate controllers communicating over one or more communication buses.

The human-machine interface may allow a user to select assist levels, view battery status, perform diagnostics, and adjust operating parameters.

### Regenerative Braking

In some embodiments, the hub motor operates as a generator during deceleration or coasting. Mechanical rotational energy is converted into electrical energy and routed through rectifier circuitry to recharge a battery or energy storage system.

Regenerative braking strength may be adjustable through the human-machine interface. Regenerative braking may provide speed stabilization, improved downhill control, and reduced mechanical brake wear.

In some embodiments, the hub motor may operate selectively in a propulsion mode, a regeneration mode, or a combined blended mode in which propulsion and energy recovery are dynamically balanced based on operating conditions.

### Operational Characteristics

The emulated multi-phase configuration enables high torque at low rotational speeds. This characteristic allows elimination of planetary gear reduction systems in some embodiments, reducing mechanical complexity and improving reliability.

Sector angles between magnetic engagement regions may be selected to produce proportional flux interruption similar to a higher-speed motor, thereby improving torque density while maintaining a compact form factor.

Thermal sensors may monitor stator temperature, rotor temperature, or bearing temperature. Control circuitry may adjust operating parameters to protect the motor from overheating.

### Bicycle and Mobility Integration

In example embodiments, the hub motor is integrated into a bicycle, scooter, skateboard, or other mobility platform. The mobility platform may include a frame, a battery, a controller, a human-machine interface, and various sensors.

Pedal cadence sensors, torque sensors, accelerometers, or gyroscopes may provide input to the motor controller. Motor output may be modulated based on these inputs.

Wireless communication may be used between sensors and the motor controller in some embodiments.

### Manufacturing and Assembly

The hub motor assembly may be assembled using thermal press-fit techniques, structural adhesive bonding, mechanical fastening, or combinations thereof. Components may be indexed to ensure proper angular alignment.

Additive manufacturing techniques may be used to form stator frames, rotor frames, or composite magnetic structures. Machining, forging, casting, or molding may be used for structural components.

Material selection may be varied depending on desired strength, weight, thermal conductivity, and corrosion resistance.

It will be understood that the number of stator poles, rotor poles, or magnet segments may be varied, that phase emulation schemes may vary, that magnet arrangements may vary from Halbach arrays to other magnetization patterns, that support shaft geometries may vary, that freehub interfaces may vary, that disc brake mounting standards may vary, that thru-axle diameters and spacings may vary, and that control architectures may be centralized or distributed, with each of these variations remaining within the scope of the disclosed principles.

In some embodiments, the hub motor system may be configured for front-wheel, rear-wheel, or mid-wheel integration. In other embodiments, the hub motor system may be used in non-bicycle mobility platforms including scooters, tricycles, wheelchairs, carts, robots, industrial transport devices, or autonomous delivery vehicles. The disclosed architectures are not limited to human-powered mobility systems.

In further embodiments, the hub motor system may be integrated into industrial carts, warehouse vehicles, medical mobility devices, robotic transport platforms, autonomous delivery systems, agricultural vehicles, or military mobility platforms. The disclosed architectures are not limited to consumer transportation applications.

In some embodiments, control logic for commutation, regeneration, torque modulation, thermal management, and diagnostic monitoring may be implemented using firmware, software, programmable logic, or combinations thereof. Control parameters may be stored in non-transitory memory and dynamically updated based on sensor feedback, operating mode, regulatory limits, or user preferences.

### Method Embodiments

Example embodiments further include methods of operating an electric hub motor, comprising energizing stator windings in emulated multi-phase firing sequences, modulating motor output based on user input and sensor feedback, operating the motor in a regenerative mode during deceleration, monitoring thermal and positional conditions, and transmitting combined motor and drivetrain torque through a reaction flange to a hub shell body.

### Non-Limiting Nature

The foregoing description describes example embodiments only. The scope of the invention is defined by the claims. No feature described herein is intended to be essential unless expressly recited in the claims. Features described in connection with one embodiment may be combined with features of other embodiments.

The terminology used herein is selected for clarity and instructional purposes and is not intended to limit the scope of the invention.

Although specific embodiments have been illustrated and described, it will be apparent to those of ordinary skill in the art that numerous modifications, substitutions, and variations may be made without departing from the scope of the invention. Accordingly, the invention is not to be limited except as set forth in the following claims.

Sensor systems described herein are optional and may include one or more of temperature sensors, position sensors, current sensors, voltage sensors, strain sensors, inertial sensors, or combinations thereof. In some embodiments, certain sensors may be omitted or replaced with inferred or model-based estimation techniques.

Power for the hub motor system may be supplied by rechargeable batteries, supercapacitors, fuel cells, hybrid energy storage systems, or external power sources. Energy storage and delivery architectures may be centralized or distributed.

In some embodiments, the hub motor system may operate within regulatory power, speed, or torque limits based on jurisdictional requirements. Control logic may enforce such limits dynamically based on operating mode or location.

Unless expressly stated otherwise, singular elements may include plural implementations, and plural elements may include singular implementations. Numerical ranges are inclusive of endpoints unless explicitly stated otherwise.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Although specific materials are described in certain embodiments, alternative materials having similar structural, thermal, magnetic, or electrical properties may be substituted. For example, aluminum alloys, magnesium alloys, composite materials, ceramics, or hybrid materials may be used in various structural components without departing from the disclosed principles.

In some embodiments, dimensional tolerances, surface finishes, and alignment tolerances may be selected based on application requirements. Precision may be achieved through machining, additive manufacturing, post-processing, or hybrid manufacturing techniques. Minor dimensional variations are not intended to affect the scope of the disclosed architectures.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A hub motor adaptable for integration into mobility systems, comprising:
a synchronous permanent magnet brushless direct current (BLDC) outrunner mechanism configurable in at least one of a 6-, 9-, or 12-phase configuration;
a stator having integrated commutation and regeneration circuitry; and
a hubshell reaction flange to transmit combined inputs of motor-assist to a hub shell body.

2. The hub motor of claim 1, wherein the stator is structured around a hollow motor-stator support shaft.

3. The hub motor of claim 1, wherein a support shaft is made from non-magnetic material.

4. The hub motor of claim 1, further comprising a mechanism for real-time communication with a motor controller.

5. The hub motor of claim 4, wherein the mechanism for real-time communication with the motor controller is via a 5-pin communication bus wire.

6. The hub motor of claim 1, further comprising a hollow motor-stator support shaft.

7. The hub motor of claim 6, wherein the hollow motor-stator support shaft comprises a strain-hardened 304-series stainless steel.

8. The hub motor of claim 1, further comprising an interface compatible with a thru-axel.

9. The hub motor of claim 8, further comprising an interface compatible with a thru-axel.

10. The hub motor of claim 8, wherein the interface is compatible with a 12 mm thru-axle.

11. The hub motor of claim 1, further comprising a housing within a flanged hub shell.

12. The hub motor of claim 11, wherein the housing within a flanged hub shell is suitable for at least one of a 28-hole or 32-hole alignment.

13. The hub motor of claim 1, further comprising a disc brake mounting flange.

14. The hub motor of claim 13, wherein the disc brake mounting flange comprises an ISO-6 bolt disc brake mounting flange.

15. The hub motor of claim 1, further comprising two direct current power wires and a 5-pin communication bus wire.

16. An e-bike system comprising:
a hub motor including:
a synchronous permanent magnet brushless direct current (BLDC) outrunner mechanism configurable in at least one of a 6-, 9-, or 12-phase configuration,
a stator having integrated commutation and regeneration circuitry, and
a hubshell reaction flange to transmit combined inputs of motor-assist to a hub shell body;
a bike frame designed around said hub motor;
a thru axle securing the hub motor within a drive wheel of the bike;
a crank-mounted cadence counter configured to gauge pedal speed and activate the hub motor's power assist accordingly;
a human-machine interface allowing users to interact with the e-bike system, modify settings, view battery status, and perform diagnostic tests;
a wireless communication system between the hub motor and a crank-mounted strain gauge to measure force applied to the pedals and modulate the hub motor's torque in response; and
a regenerative braking system where the hub motor acts as a generator during coasting or descending to convert kinetic energy back into stored electrical energy.

17. The e-bike system of claim 16, wherein the human-machine interface provides real-time feedback regarding the hub motor's operation and battery life.

18. The e-bike system of claim 16, wherein the crank-mounted strain gauge communicates wirelessly with the hub motor to adjust the hub motor's torque based on the force exerted on the pedals.

19. The e-bike system of claim 16, wherein the regenerative braking system conserves battery life and offers rear-biased speed control.

20. The e-bike system of claim 16, wherein the stator of the hub motor is structured around a hollow motor-stator support shaft.

21-25. (canceled)
